(19) United States
(12) Patent Application Publication
(10) Pub. No.: US 2026/0172971 A1
(43) Pub. Date: Jun. 18, 2026

(54) SIGNAL TRANSMITTING AND RECEIVING METHOD, DEVICE, AND STORAGE MEDIUM

(71) Applicant: ZTE CORPORATION, Shenzhen (CN)

(72) Inventors: Qiujin GUO, Shenzhen (CN); Mengzhu CHEN, Shenzhen (CN); Jun XU, Shenzhen (CN); Bo DAI, Shenzhen (CN); Kun LIU, Shenzhen (CN); Weiwei YANG, Shenzhen (CN); Youjun HU, Shenzhen (CN)

(73) Assignee: ZTE CORPORATION, Shenzhen (CN)

(21) Appl. No.: 19/532,774

(22) Filed: Feb. 6, 2026

Related U.S. Application Data
(63) Continuation of application No. PCT/CN2023/111849, filed on Aug. 8, 2023.

(51) Int. Cl. H04W 52/02; H04L 27/26; H04W 52/14

(52) U.S. Cl. CPC H04W 52/0235; H04L 27/2636; H04W 52/143

(57) ABSTRACT

A wireless communication method for use in a wireless terminal and the purpose of wireless terminal and wireless node power saving is disclosed. The method comprises receiving, from a wireless network node, configuration information of a low-power signal and/or cell discontinuous transmission/reception, and monitoring the low-power signal and/or physical control channel, PDCCH, based on the configuration information, wherein the low-power signal comprises a first low-power signal and a second low-power signal, and wherein the low-power signal is associated with triggering the wireless terminal to leave a low-power state.

### CROSS-REFERENCE TO RELATED PATENT APPLICATIONS

The present disclosure is a continuation of PCT Application No. PCT/CN2023/111849, filed Aug. 8, 2023, the entire content of which is incorporated into the present application by reference.

### TECHNICAL FIELD

This document is directed generally to wireless communications, and in particular to 5G communications.

### BACKGROUND

In the existing technologies, time-frequency synchronization is allowed to be based on ZC (Zadoff-Chu) sequences, m sequences, and PN (pseudo-noise) sequences. For example, PSS (primary synchronization signal) and SSS (secondary synchronization signal) used for the time-frequency synchronization may be based on one of these sequences. Sequence-based modulation can also be used to carry indication information.

### SUMMARY

Modulation schemes including ASK, OOK, FSK, BPSK, π/2-BPSK and QPSK are used to modulate raw information bits or bit sequence.

This document relates to methods, systems, and devices for signal transmission and/or receptions, and in particular to methods, systems, and devices for low-power (LP) signal transmission and/or receptions.

The present disclosure relates to a wireless communication method for use in a wireless terminal. The method comprises:
receiving, from a wireless network node, configuration information of a low-power signal, and
monitoring the low-power signal based on the configuration information.

Various embodiments may preferably implement the following features:

Preferably or in some embodiments, the low-power signal comprises a first low-power signal and a second low-power signal.

Preferably or in some embodiments, the low-power signal is associated with triggering the wireless terminal to leave a low-power state.

Preferably or in some embodiments, indication information comprised in the low-power signal comprises at least one of: a cell identifier (ID), a wireless terminal group ID, a wireless terminal sub-group ID, a wireless terminal ID, an indication of whether system information changes, emergency disaster information, tracking area information, radio access network area information, a low-power signal format, timing information, master information, system information, control information configured to schedule data for the wireless terminal, access information associated with an access procedure, paging information associated with receiving paging from the wireless network node, data, a wake-up indication associated with triggering the wireless terminal to leave the low-power state, an activation of monitoring the low-power signal, a deactivation of monitoring the low-power signal, or a start discontinuous reception timer.

Preferably or in some embodiments, information bits carried by the low-power signal is divided into C blocks, wherein C is a positive integer.

Preferably or in some embodiments, the C blocks comprises at least one information block which comprises information bits of indication information comprised in the low-power signal and/or at least one cyclic redundance check (CRC) block comprising CRC bits of the at least one information block.

Preferably or in some embodiments, C is determined based on at least one of: a number of wireless terminal groups, a number of wireless terminal sub-group, a number of wireless terminals in a group, a number of wireless terminals in a cell, a number of the information bits, a length of zero padding, a length of sequence used for generating the low-power signal, a number of resource elements allocated for the low-power signal, or a maximum number of bits carried by single block

Preferably or in some embodiments, each information block indicates at least one of the indication information and/or a type of the indication information comprised in the low-power signal.

Preferably or in some embodiments, the CRC bits is carried by a sequence.

Preferably or in some embodiments, the length of the CRC bits is 6, 8, 10 or 11.

Preferably or in some embodiments, a number of CRC blocks is determined based on at least one of a number of bits carried by single information block a number of the information blocks, a type of the low-power signal or the number of the information bits carried by the low-power signal.

Preferably or in some embodiments, the length of the information bits carried by the C blocks is determined by:

$$⌈ \frac{L}{A} ⌉ \cdot A$$

wherein L is a number of the information bits carried by the low-power signal, A is a number of bits carried by single information block, an

$$C = ⌈ \frac{L}{A} ⌉$$

Preferably or in some embodiments, A is not less than 2 and/or is not larger than 8.

Preferably or in some embodiments, at least one of indication information of the low-power signal is configured with a priority level.

Preferably or in some embodiments, a budget size of the low-power signal is not smaller than 8 bits and is not larger than 24 bits.

Preferably or in some embodiments, indication information is classified into a plurality of information sets,

Preferably or in some embodiments, the low-power signal carries at least one indication information of one of the plurality of information sets based on an information type of the low-power signal.

Preferably or in some embodiments, the plurality of information sets comprises at least one of:
a first information set, including at least one of timing information, a cell ID, a wireless terminal group ID, a wireless terminal subgroup ID, or a wireless terminal ID,
a second information set, including at least one of a low-power signal format or the information type of the low-power signal,
a third information set, including at least one of a wake-up indication, an activation of monitoring the low-power signal, a deactivation of monitoring the low-power signal, an indication of a system information change, emergency disaster information, tracking area information, radio access network area information, a Start DRX timer, paging information or access information, or
a fourth information set, including at least one of the wake-up indication, the activation of monitoring the low-power signal, the deactivation of monitoring the low-power signal, the indication of the system information change, the emergency disaster information, the tracking area information, the radio access network area information, the Start DRX timer, the paging information, the access information, control information, system information, master information or data.

Preferably or in some embodiments, the at least one indication information carried by the low-power signal is determined based on at least one of the type of the low-power signal, a number of information bits of the low-power signal, a budget size of the low-power signal, a format of the low-power signal, or a resource configuration of the low-power signal.

Preferably or in some embodiments, the first low-power signal is configured to carry indication information.

Preferably or in some embodiments, the second low-power signal is configured to carry synchronization information.

Preferably or in some embodiments, the first low-power signal comprises:
a first low-power signal format 0, which is determined by at least one of a sequence used to modulate information bits of the first low-power signal, a DFT-s-OFDM transformation, a transform precoder, a segmentation method in frequency domain or a repetition method in time domain,
a first LP signal format 1, which is determined by at least one of a sequence used to modulate information bits of the first low-power signal, an orthogonal cover code of the first low-power signal, a time spreading method, a frequency hopping method or a block segmentation method,
a first LP signal format 2, which is determined by at least one of a modulation scheme, a forward error correction coding method or a transforming precoder,
a first LP signal format 3, which is determined by at least one of a modulation scheme, an FEC coding method, a block segmentation method, a transforming precoder or a frequency hopping method,
a first LP signal format 4, which is determined by at least one of a sequence used to modulate information bits of the first low-power signal, a time spreading method, a repetition method or a frequency hopping method, or
a first LP signal format 5, which is determined by at least one of a modulation scheme, a sequence used to modulate information bits of the first low-power signal, an FEC coding method, a time spreading method, a repetition method or a frequency hopping method.

Preferably or in some embodiments, a format of the first low-power signal is determined based on at least one of indication information set corresponding the first low-power signal, processing steps of generating the first low-power signal, a resource set ID or a set of candidate sequences used to modulate information bits of the first low-power signal.

Preferably or in some embodiments, resource information of the first low-power signal comprises at least one of:
a resource set ID,
a frequency hopping method,
a frequency offset used to transmit the first low-power signal,
an indication of whether to set sampling values corresponding to a middle of the frequency band allocated for transmitting the first low-power signal to zero.
a start frequency location of the first low-power signal,
a frequency of the first low-power signal,
a format of the first low-power signal,
a first symbol in which the first low-power signal is transmitted,
a duration for detecting the first low-power signal,
a physical resource block offset,
a starting physical resource block offset,
an orthogonal frequency-division multiplexing symbol indication of time-domain resource allocated for the first low-power signal
a number of physical resource blocks allocated for the first low-power signal,
a cyclic shift index set,
a wireless terminal group ID, a wireless terminal sub-group ID, or a wireless terminal ID used to determine an initial value of generating a sequence which is used to modulate information bits carried by the first low-power signal,
a multi-symbol transmission indication of whether the first low-power signal is transmitted in multiple symbols,
a number of information bits carried by the first low-power signal, or
an interval of the start frequency location of the first low-power signal and a start frequency location of a prestored sequency.

Preferably or in some embodiments, the second low-power signal comprises at least one of a synchronization signal/physical broadcast channel block, a primary synchronization signal sequence, a secondary synchronization signal sequence, an m sequence, or a pseudo noise sequence.

Preferably or in some embodiments, indication information indicated by the second low-power signal comprises at least one of: a cell ID, a wireless terminal group ID, a wireless terminal sub-group ID, a wireless terminal ID, a wake-up indication, an activation of monitoring the first low-power signal, or a deactivation of monitoring the first low-power signal.

Preferably or in some embodiments, configuration information of the second low-power signal comprises at least one of: a measurement period of measuring the second low-power signal, a frequency of the second low-power signal, a reference signal configuration of the second low-power signal, a subcarrier spacing configuration of the second low-power signal, a configuration for mobility, a multiplexing mode, indicating a multiplexing mode between at least two of the first low-power signal, the second low-power signal and a synchronization signal/physical broadcast channel block, a power of the first low-power signal, a power of the second low-power signal, a pattern of the first low-power signal, a pattern of the second low-power signal, a location and a bandwidth of the second low-power signal, or a reference point.

Preferably or in some embodiments, an occasion of monitoring the first low-power signal during a periodicity of the first low-power signal is associated with at least one second low-power signal during the periodicity.

Preferably or in some embodiments, a first occasion of monitoring the second low-power signal is overlapped with a second occasion of monitoring a synchronization signal/physical broadcast channel block.

Preferably or in some embodiments, the wireless communication method further comprises: stop monitoring the second low-power signal in the first occasion, and/or monitoring at least one of a synchronization signal block, a primary synchronization signal, or secondary synchronization signal of the synchronization signal/physical broadcast channel block.

Preferably or in some embodiments, a third occasion of monitoring the first low-power signal is overlapped with a fourth occasion of monitoring a synchronization signal/physical broadcast channel block.

Preferably or in some embodiments, the wireless communication method further comprises stopping monitoring the second low-power signal in the third occasion

The present disclosure relates to a wireless communication method for use in a wireless network node. The method comprises:
transmitting, to a wireless terminal, configuration information of a low-power signal, and
transmitting the low-power signal based on the configuration information.

Various embodiments may preferably implement the following features:

Preferably or in some embodiments, the low-power signal comprises a first low-power signal and a second low-power signal.

Preferably or in some embodiments, the low-power signal is associated with triggering the wireless terminal to leave a low-power state.

Preferably or in some embodiments, indication information comprised in the low-power signal comprises at least one of: a cell identifier (ID), a wireless terminal group ID, a wireless terminal sub-group ID, a wireless terminal ID, an indication of whether system information changes, emergency disaster information, tracking area information, radio access network area information, a low-power signal format, timing information, master information, system information, control information configured to schedule data for the wireless terminal, access information associated with an access procedure, paging information associated with receiving paging from the wireless network node, data, a wake-up indication associated with triggering the wireless terminal to leave the low-power state, an activation of monitoring the low-power signal, a deactivation of monitoring the low-power signal, or a start discontinuous reception timer.

Preferably or in some embodiments, information bits carried by the low-power signal is divided into C blocks, wherein C is a positive integer.

Preferably or in some embodiments, the C blocks comprises at least one information block which comprises information bits of indication information comprised in the low-power signal and/or at least one cyclic redundance check (CRC) block comprising CRC bits of the at least one information block.

Preferably or in some embodiments, C is determined based on at least one of: a number of wireless terminal groups, a number of wireless terminal sub-group, a number of wireless terminals in a group, a number of wireless terminals in a cell, a number of the information bits, a length of zero padding, a length of sequence used for generating the low-power signal, a number of resource elements allocated for the low-power signal, or a maximum number of bits carried by single block Preferably or in some embodiments, each information block indicates at least one of the indication information and/or a type of the indication information comprised in the low-power signal.

Preferably or in some embodiments, the CRC bits is carried by a sequence.

Preferably or in some embodiments, the length of the CRC bits is 6, 8, 10 or 11.

Preferably or in some embodiments, a number of CRC blocks is determined based on at least one of a number of bits carried by single information block a number of the information blocks, a type of the low-power signal or the number of the information bits carried by the low-power signal.

Preferably or in some embodiments, the length of the information bits carried by the C blocks is determined by:

$$⌈ \frac{L}{A} ⌉ \cdot A$$

wherein L is a number of the information bits carried by the low-power signal, A is a number of bits carried by single information block, and

$$C = ⌈ \frac{L}{A} ⌉$$

Preferably or in some embodiments, A is not less than 2 and/or is not larger than 8.

Preferably or in some embodiments, at least one of indication information of the low-power signal is configured with a priority level.

Preferably or in some embodiments, a budget size of the low-power signal is not smaller than 8 bits and is not larger than 24 bits.

Preferably or in some embodiments, indication information is classified into a plurality of information sets,

Preferably or in some embodiments, the low-power signal carries at least one indication information of one of the plurality of information sets based on an information type of the low-power signal.

Preferably or in some embodiments, the plurality of information sets comprises at least one of:
a first information set, including at least one of timing information, a cell ID, a wireless terminal group ID, a wireless terminal subgroup ID, or a wireless terminal ID,
a second information set, including at least one of a low-power signal format or the information type of the low-power signal,
a third information set, including at least one of a wake-up indication, an activation of monitoring the low-power signal, a deactivation of monitoring the low-power signal, an indication of a system information change, emergency disaster information, tracking area information, radio access network area information, a Start DRX timer, paging information or access information, or
a fourth information set, including at least one of the wake-up indication, the activation of monitoring the low-power signal, the deactivation of monitoring the low-power signal, the indication of the system information change, the emergency disaster information, the tracking area information, the radio access network area information, the Start DRX timer, the paging information, the access information, control information, system information, master information or data.

Preferably or in some embodiments, the at least one indication information carried by the low-power signal is determined based on at least one of the type of the low-power signal, a number of information bits of the low-power signal, a budget size of the low-power signal, a format of the low-power signal, or a resource configuration of the low-power signal.

Preferably or in some embodiments, the first low-power signal is configured to carry indication information.

Preferably or in some embodiments, the second low-power signal is configured to carry synchronization information.

Preferably or in some embodiments, the first low-power signal comprises:
a first low-power signal format 0, which is determined by at least one of a sequence used to modulate information bits of the first low-power signal, a DFT-s-OFDM transformation, a transform precoder, a segmentation method in frequency domain or a repetition method in time domain,
a first LP signal format 1, which is determined by at least one of a sequence used to modulate information bits of the first low-power signal, an orthogonal cover code of the first low-power signal, a time spreading method, a frequency hopping method or a block segmentation method,
a first LP signal format 2, which is determined by at least one of a modulation scheme, a forward error correction coding method or a transforming precoder,
a first LP signal format 3, which is determined by at least one of a modulation scheme, an FEC coding method, a block segmentation method, a transforming precoder or a frequency hopping method,
a first LP signal format 4, which is determined by at least one of a sequence used to modulate information bits of the first low-power signal, a time spreading method, a repetition method or a frequency hopping method, or
a first LP signal format 5, which is determined by at least one of a modulation scheme, a sequence used to modulate information bits of the first low-power signal, an FEC coding method, a time spreading method, a repetition method or a frequency hopping method.

Preferably or in some embodiments, a format of the first low-power signal is determined based on at least one of indication information set corresponding the first low-power signal, processing steps of generating the first low-power signal, a resource set ID or a set of candidate sequences used to modulate information bits of the first low-power signal.

Preferably or in some embodiments, resource information of the first low-power signal comprises at least one of:
a resource set ID,
a frequency hopping method,
a frequency offset used to transmit the first low-power signal,
an indication of whether to set sampling values corresponding to a middle of the frequency band allocated for transmitting the first low-power signal to zero.
a start frequency location of the first low-power signal,
a frequency of the first low-power signal,
a format of the first low-power signal,
a first symbol in which the first low-power signal is transmitted,
a duration for detecting the first low-power signal,
a physical resource block offset,
a starting physical resource block offset,
an orthogonal frequency-division multiplexing symbol indication of time-domain resource allocated for the first low-power signal
a number of physical resource blocks allocated for the first low-power signal,
a cyclic shift index set,
a wireless terminal group ID, a wireless terminal sub-group ID, or a wireless terminal ID used to determine an initial value of generating a sequence which is used to modulate information bits carried by the first low-power signal,
a multi-symbol transmission indication of whether the first low-power signal is transmitted in multiple symbols,
a number of information bits carried by the first low-power signal, or
an interval of the start frequency location of the first low-power signal and a start frequency location of a prestored sequency.

Preferably or in some embodiments, the second low-power signal comprises at least one of a synchronization signal/physical broadcast channel block, a primary synchronization signal sequence, a secondary synchronization signal sequence, an m sequence, or a pseudo noise sequence.

Preferably or in some embodiments, indication information indicated by the second low-power signal comprises at least one of: a cell ID, a wireless terminal group ID, a wireless terminal sub-group ID, a wireless terminal ID, a wake-up indication, an activation of monitoring the first low-power signal, or a deactivation of monitoring the first low-power signal.

Preferably or in some embodiments, configuration information of the second low-power signal comprises at least one of: a measurement period of measuring the second low-power signal, a frequency of the second low-power signal, a reference signal configuration of the second low-power signal, a subcarrier spacing configuration of the second low-power signal, a configuration for mobility, a multiplexing mode, indicating a multiplexing mode between at least two of the first low-power signal, the second low-power signal and a synchronization signal/physical broadcast channel block, a power of the first low-power signal, a power of the second low-power signal, a pattern of the first low-power signal, a pattern of the second low-power signal, a location and a bandwidth of the second low-power signal, or a reference point.

Preferably or in some embodiments, an occasion of monitoring the first low-power signal during a periodicity of the first low-power signal is associated with at least one second low-power signal during the periodicity.

The present disclosure relates to wireless terminal. The wireless terminal comprises:
a communication unit, configured to receive, from a wireless network node, configuration information of a low-power signal, and
a processor, configured to monitor the low-power signal based on the configuration information.

Various embodiments may preferably implement the following features:

Preferably or in some embodiments, the low-power signal comprises a first low-power signal and a second low-power signal.

Preferably or in some embodiments, the low-power signal is associated with triggering the wireless terminal to leave a low-power state.

Preferably or in some embodiments, the processor is further configured to perform any of aforementioned wireless communication methods.

The present disclosure relates to a wireless network node. The wireless network node comprises:
a communication unit, configured to: transmit, to a wireless terminal, configuration information of a low-power signal, and transmit the low-power signal based on the configuration information.

Various embodiments may preferably implement the following features:

Preferably or in some embodiments, the low-power signal comprises a first low-power signal and a second low-power signal.

Preferably or in some embodiments, the low-power signal is associated with triggering the wireless terminal to leave a low-power state.

Preferably or in some embodiments, the wireless network node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF DRAWINGS

FIG. 1 shows a schematic diagram of different types of frequency and time domain locations for two blocks carrying the indication information of the LP signal according to an embodiment of the present disclosure.

FIG. 2 shows a schematic diagram of blocks for a LP signal transmission according to an embodiment of the present disclosure.

FIG. 3 shows a schematic diagram of the LP signal according to an embodiment of the present disclosure.

FIG. 4 shows a schematic diagram of a first LP signal format 1 according to an embodiment of the present disclosure.

FIG. 5 shows a schematic diagram of a first LP signal according to an embodiment of the present disclosure.

FIG. 6 shows a schematic diagram of a frequency band according to an embodiment of the present disclosure.

FIG. 7 shows a schematic diagram of an OFDM symbol according to an embodiment of the present disclosure.

FIG. 8 shows a schematic diagram of OFDM symbols according to an embodiment of the present disclosure.

FIG. 9 shows schematic diagrams of repetition modes according to an embodiment of the present disclosure.

FIG. 10 shows schematic diagrams of hopping modes according to an embodiment of the present disclosure.

FIG. 11 shows schematic diagrams of the first LP signal according to embodiments of the present disclosure.

FIG. 12 shows a schematic diagram of mapping rules of the prestored sequence and the first LP signal according to an embodiment of the present disclosure.

FIG. 13 shows a flowchart of a method according to an embodiment of the present disclosure.

FIG. 14 shows a flowchart of a procedure according to an embodiment of the present disclosure.

FIG. 15 shows a flowchart of a procedure according to an embodiment of the present disclosure.

FIG. 16 shows a schematic diagram of the measurement period according to an embodiment of the present disclosure.

FIG. 17 shows a schematic diagram of the measurement period according to an embodiment of the present disclosure.

FIG. 18 shows schematic diagrams of multiplexing patterns according to embodiments of the present disclosure.

FIG. 19 shows a schematic diagram of the first LP signal and second LP signal according to an embodiment of the present disclosure.

FIG. 20 shows a schematic diagram of relationship between the first LP signal and the second LP signal according to an embodiment of the present disclosure.

FIG. 21 shows a schematic diagram of a second LP signal according to an embodiment of the present disclosure.

FIG. 22 shows a schematic diagram of generating a low-power wake-up signal according to an embodiment of the present disclosure.

FIG. 23 shows a schematic diagram of a second LP signal according to an embodiment of the present disclosure.

FIG. 24 shows a schematic diagram of a network (architecture) according to an embodiment of the present disclosure.

FIG. 25 shows an example of a schematic diagram of a wireless terminal according to an embodiment of the present disclosure.

FIG. 26 shows an example of a schematic diagram of a wireless network node according to an embodiment of the present disclosure.

### DETAILED DESCRIPTION

In the present disclosure, the LP signal may be a LP wake-up signal (WUS).

In the present disclosure, a frequency may refer to a frequency point and/or the frequency domain resource assignment for LP signal transmissions.

Low power signal (LP signal) can trigger a UE (user equipment) to stop performing UE behaviors or to wake up the UE to start performing the UE behaviors. The UE behaviors, which cost UE more power consumption than in a sleep state, include PDCCH (physical downlink control channel) monitoring, PDSCH (physical downlink shared channel) reception and PUCCH/PUSCH (physical uplink control channel/physical uplink shared channel) transmission, etc. In addition, the UE may use a low power receiver (LP receiver) consisting by low power components to detect the LP signal in a low power state, rather than using a main radio receiver (e.g., main radio of NR (new radio). By using the low power receiver the UE spends lower power consumption for detecting the LP signal. Therefore, the UE can have a longer battery life.

The present disclosure provides a LP signal design, to ensure that the UE can receive the LP signal by both the LP receiver and the main radio of NR, to take the backward compatibility into consideration. Moreover, a mobility support function (e.g., measurement capability) is also provided for the LP signal and the LP receiver.

In some embodiments, a BS (base station) transmits (a plurality of) configuration information to a UE and the UE monitors an LP signal based on the configuration information.

In an embodiment, the indication information of the LP signal (e.g., the information indicated by or comprised/included in the LP signal) includes at least one of the following information or indication fields:
a. Cell ID
b. UE-group ID, UE-subgroup ID or UE-ID
c. SI (system information) change (indication)
d. ETWS/CMAS (Earthquake and Tsunami Warning System/Commercial Mobile Alert System) information
e. tracking area information f RAN area information
g. LP signal format
h. SFN (system frame number): The SFN is configured to indicate a timing for LP signal transmission and/or a frame number where the LP signal is transmitted;
i. Master information, it includes at least one of the information carried by master information block (MIB), and/or the MIB configuration/change information;
j. System information: The system information includes at least one of the information carried by system information block (SIB), which includes at least one of the SIB1 to SIB17, and/or the information associated with a short massage;
k. Control information: The control information is configured to indicate at least one of the following information associated with scheduling information:
   a) Time/frequency resource allocation for data transmission;
   b) UL control information, it includes at least one of the control information indicated by DCI format 0-1/0-1/0-2 and/or DCI format 3-0/3-1 and/or DCI format 4-0/4-1/4-2;
   c) DL control information, it includes at least one of the control information indicated by DCI format 1-0/1-1/1-2 and/or DCI format 3-0/3-1 and/or DCI format 4-0/4-1/4-2;
For example, the control information may be used to schedule data for a passive IoT (internet of things) node and/or a UE.
l. Access information: The Access information may include at least one of the information carried by msg1, msg2, msg3, msg4, msgA, and/or msgB (i.e., message(s) of a random access process), an indication whether the UE needs to perform access and/or transmit a preamble, etc.
m. Paging information: The paging information may include at least one of the information indicated by the DCI format 1-0 scrambled with a P-RNTI (paging radio network temporary identifier), and/or the information indicated by DCI format 2-7 for indicating whether the UE needs to monitor a paging occasion;
n. Data: The data may include at least one of the data information scheduled by PDCCH or higher layer parameter, and/or the semi-persistent data transmission/reception, and/or the persistent data transmission/reception, and/or the small data transmission/reception;
o. Wake-up indication: The wake-up indication is configured to indicate the UE whether to start or to stop monitoring the PDCCH, and/or to start or stop performing the UE behaviors (by using the main radio of NR);
p. Activation/deactivation of LP signal monitoring: The UE stops monitoring the LP signal if the LP signal monitoring is deactivated and/or the UE starts monitoring the LP signal if the LP signal monitoring is activated;
q. Information type: The information type indicates a set of information, and/or a priority level of the information, and/or a type of information carried by a type of LP signal or a LP signal format; or
r. Start DRX timer: The Start DRX (discontinuous) timer indicates the UE whether to start or not to start a DRX timer.

In some embodiments, the indication method of the above indication information includes/accords to at least one of the followings methods.

In an embodiment, the indication method of the above indication information may adopt Block segmentation. In this embodiment, the indication information carried by the LP signal is divided in C blocks, wherein C is an integer that is not smaller than 1. The C blocks include at least one of information block(s) and CRC (cyclic redundance check) block(s), wherein the information block is configured to carry information bits associated with the indication information and the CRC block is configured to carry at least one of CRC bits corresponding to the information bits. The number of information blocks is determined by at least one of the number of UE groups/UE subgroups, the number of UEs in a group/cell, the number of information bits, the length of ZP (zero prefix), the length of sequence, the number of REs allocated for LP signal, and/or the maximum number of bits carried by a block.

In an embodiment of block segment, every two blocks have different types of frequency and time domain locations.

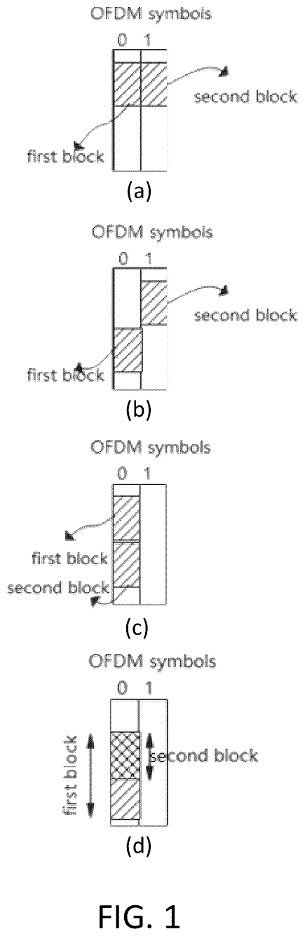

FIG. 1 shows a schematic diagram of different types of frequency and time domain locations for two blocks carrying the indication information of the LP signal according to an embodiment of the present disclosure.

In FIG. 1(a), a first block and a second block have the same frequency domain resource location and different time domain resource locations.

In FIG. 1(b), the first block and the second block have different frequency domain resource locations and different time domain resource locations. Note that the first block and the second block may carry the same information and/or the resource relationship between the two blocks is noted as hopping. As an alternative, the first block and second block carry different indication information.

In FIG. 1(c), the first block and the second block have different frequency domain resource locations and the same time domain resource location. In an embodiment, the first block and the second block carry different information and/or the two blocks are frequency segmented. In an embodiment, the first block and the second block carry the same information and/or the resource relationship between the two blocks is noted as hopping.

In FIG. 1(d), the first block and second block have different frequency domain resource locations and the same time domain resource locations and/or have different types of sequences and/or gave different processing procedures. These two blocks have the same start of the PRB or frequency domain resource and different numbers of PRBs or frequency domain resources. In an embodiment, the first block and second block carry different information and/or the two blocks are frequency-domain segmented. As an alternative, the first block and the second block carry the same information and/or the resource relationship between the two blocks is noted as hopping.

In an embodiment of the block segment, one information block carries/indicates at least one of a whole information field and/or a type of above indication information. For example, each block carries 2-bit information to indicate the LP signal format.

In an embodiment of block segment, the CRC bits are carried by sequence. The length of the CRC bits includes at least one of 6, 8, 10 and 11. The CRC bits can be divided into a number of CRC blocks and the number of CRC blocks may be determined by the number of bits carried by single information block and/or the total number of information blocks and/or the type of the LP signal and/or the number of information bits carried by the LP signal. For example, the number of information bits indicated by one block is 5 and the length of CRC bits is equal to 10. In this example, the number of CRC blocks is 2.

In an embodiment of block segment, the length L of the information bits carried by LP signal can be evenly divisible by the (maximum) number A of information bits carried by one block and/or the number C of information blocks. For example, the length of the information bits is determined by

$$⌈ \frac{L}{A} ⌉ .$$

A. In this embodiment,

$$C = ⌈ \frac{L}{A} ⌉ .$$

If the length of the information bits can not be evenly divisible by A and/or C, at least one zeros bit can be attached to the end of the information bits. In an embodiment, A is not less than 2 and is not larger than 8.

In an embodiment of block segment, if the resource for the LP signal transmission is overlapped or collided with the resource for other signals/channels, the LP signal transmission may be changed. For example, the resource for the LP signal transmission may be ignored by the UE. As an alternative, the block index related to the resource for the LP signal transmission is skipped/ignored by the UE.

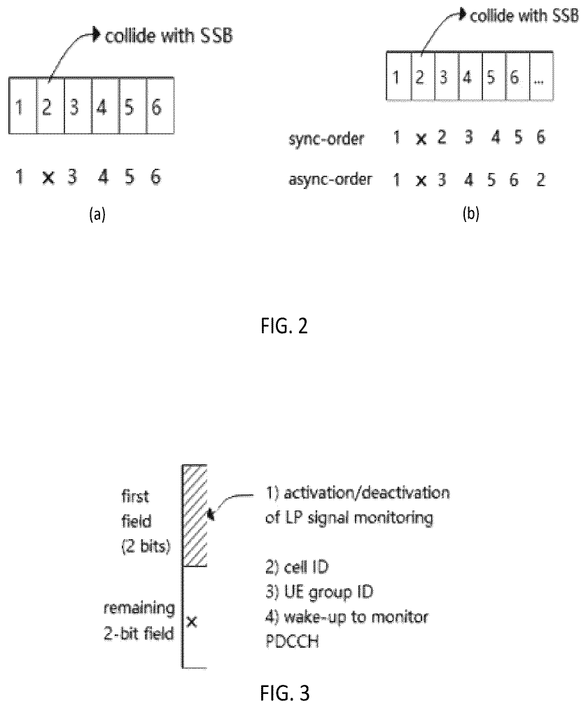

FIG. 2 shows a schematic diagram of blocks for a LP signal transmission according to an embodiment of the present disclosure. In FIG. 2(a), there are 6 blocks for the LP signal transmission and the resource for the second block is collided with the SSB. In FIG. 2(a), the second block transmission is ignored.

In FIG. 2(b), there are 6 blocks for the LP signal transmission and the resource for the second block is collided with the SSB. In this embodiment, the UE stops counting/detecting the information of the second block transmission and continues counting the information of the second block transmission in sync-order or async-order.

In an embodiment, the indication method of the indication information carried by the LP signal may be Priority level. In this embodiment, at least one of the indication information of the LP signal is configured with a priority level.

In an embodiment of the priority level, the indication information with the first/high priority level includes at least one of: the SI change, the ETWS/CMAS, the tracking area information, the RAN area information and/or the wake-up indication. The indication information with the second/medium priority level includes at least one of: the cell ID, the UE-group/UE-subgroup/UE ID, the LP signal format, the SFN, the activation/deactivation of the LP signal monitoring, the control information, etc. The indication information with the third/low priority level includes at least one of: the information type, the data, master information, the system information, the start DRX timer, etc.

In an embodiment of the priority level, the indication information with the low priority level is transmitted or is truncated if there is no additional budget size or resource allocation to carry the indication information.

In an embodiment, the budget size of the LP signal is not smaller than 8 bits and is not larger than 24 bits.

In an embodiment, the indication information includes or is classified as at least one information sets and different information sets are carried/indicated by different types of the LP signal.

In an embodiment, the indication information in a first information set includes at least one of the SFN, the timing information, the cell ID, the UE group ID, UE subgroup ID, UE ID. For example, the information of the first information set is indicated by the second LP signal or the first LP signal format 0.

In an embodiment, the indication information in a second information set includes at least one of the LP signal format and/or the information type. For example, the information of the second information set is indicated by the first LP signal format 0 and/or the first LP signal format 4.

In an embodiment, the indication information in a third information set includes at least one of the wake-up indication, the activation/deactivation of LP signal monitoring, the SI change, the ETWS/CMAS information, the tracking area information, the RAN area information, the Start DRX timer, the Paging information and/or the Access information. For example, the information of the third information set is indicated by the first LP signal format 1 and/or format 5.

In an embodiment, the indication information in a fourth information set includes at least one of the wake-up indication, the activation/deactivation of LP signal monitoring, the SI change, the ETWS/CMAS information, the tracking area information, the RAN area information, the start DRX timer, the paging information, the access information, the control information, the system information, the master information and/or the data. For example, the information of the fourth information set is indicated by the first LP signal format 2, format 3 and/or format 4.

In an embodiment, whether one of the indication information of the information set exists or not is determined according to the indication information indicated by the LP signal and/or according to the number of information bits/budget size of the LP signal or the LP signal format, according to the LP signal format, or according to the resource configuration of the LP signal.

In some embodiments, an OFDM symbol carrying an predefined sequence or all ones or all zeros sequence is located immediately before the first OFDM symbol that carrying LP signal. In some embodiments, an OFDM symbol carrying an predefined sequence or all ones or all zeros sequence is located between two OFDM symbols that carrying LP signal. The predefined sequence or all ones or all zeros sequence is mapped to the REs in frequency domain resource that is configured for the LP signal.

Note that the second LP signal and the first LP signal (formats 1, 2, 3, 4 and 5) would be further discussed in embodiments of types and/or formats of the LP signal.

FIG. 3 shows a schematic diagram of the LP signal according to an embodiment of the present disclosure. In FIG. 3, the UE is provided with the LP signal configured to include the indication information: 1) activation/deactivation of LP signal monitoring, 2) Cell ID, 3) UE-group, UE-subgroup, or UE-ID and 4) wake-up to monitor PDCCH. The number of information bits carried by the LP signal is equal to 4 according to the configuration from a higher layer. Therefore, the UE assumes that the LP signal indicates the activation/deactivation of LP signal monitoring and two zero padding bits after the field of activation/deactivation of LP signal monitoring. The UE ignores the remaining 2 bits (i.e., the zero padding bits) that do not indicate any other indication information.

In some embodiments, the LP signal includes a first LP signal and/or a second LP signal. The first LP signal carries one or more indication information bits. The second signal (which may be a synchronization signal) provides cell identification, interference rejection, synchronization and/or mobility support function (e.g., RRM measurement capability).

In an embodiment, the first LP signal includes at least one of the following formats:

### First LP Signal Format0:

The first LP signal format0 is determined by at least one of a sequence used to modulate the information bits, the DFT-s-OFDM (Discrete Fourier Transform-Spread-Orthogonal Frequency Division Multiplexing) transformation, transform precoder, segmentation in frequency domain and/or the repetition in time domain. Wherein the sequence is a preamble, a m sequence and/or ZC sequence. The information bits carried by first LP signal format0 does not needed to be divided into a plurality of blocks. For m sequence, the initial size is determined by the cell ID, the UE ID, and/or the UE subgroup ID or UE group ID. For ZC sequence or PN sequence or a complex sequence, the value of cyclic shift (N_{cs}) and/or the length of the sequence is determined by the cell ID, the UE ID, and/or the UE subgroup ID or UE group ID, and/or the indication of wake-up to PDCCH monitoring for a UE without a UE group/subgroup ID, and/or the indication of not wake-up to PDCCH monitoring for a UE without a UE group/subgroup ID.

### First LP Signal Format1:

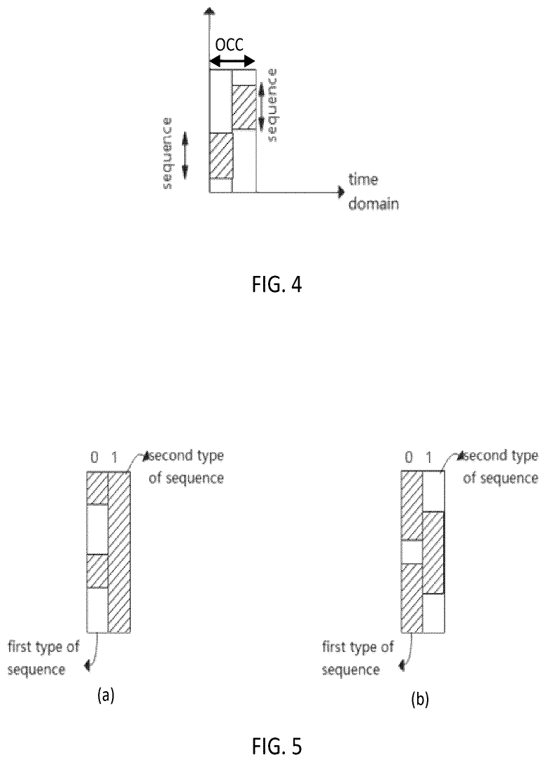

FIG. 4 shows a schematic diagram of a first LP signal format 1 according to an embodiment of the present disclosure. The first LP signal format1 is determined by at least one of a sequence, an OCC (Orthogonal Cover Code), time spreading, frequency hopping and/or block segmentation. The information bits need the block segmentation if the number of information bits is larger than A, i.e., the (maximum) number of information bits carried by one block. Each block is modulated by the sequence (e.g., ZC sequence or m sequence). The modulated sequence corresponding to the same block are spread in multiple OFDM symbols by an OCC. The length of the OCC is equal to the length of OFDM symbols occupied by one block. If the block is hopped in different frequency domain resource, the middle of the frequency band is set to 0, or a frequency offset(Δf) is added to the modulated sequence. In an embodiment, the block may be hopped in different OFDM symbols.

### First LP Signal Format2:

The first LP signal format2 is determined by at least one of a modulation scheme, FEC (forward error correction) coding and/or transforming precoder. The information bits are encoded by a Manchester code to generate a sequence 0. In an embodiment, the code rate of the Manchester code is 1/2. The sequence 0 is modulated by a modulation scheme, wherein the modulation scheme includes at least one of the QPSK (Quadrature Phase Shift Keying), BPSK (Binary Phase-shift keying), OOK (on-off keying), ASK (Amplitude-shift keying) and/or FSK (Frequency-Shift Keying). The modulated sequence is an amplitude sequence and is encoded by an FEC coding. The FEC coding includes at least one of polar code, TBCC (Tail-Biting Convolutional Code), RM (Reed-Muller) code and/or LDPC (low-density parity-check). The modulated sequence is truncated/padded to the specific length D before being processed by transforming precoder. In an embodiment, the specific length D is a product of the number of PRB and 12 and/or is a multiple of 6. As an alternative, the specific length D is determined by

$$⌈ \frac{S}{α} ⌉ \cdot α ,$$

where S is the length of the modulated sequence and α is an integer that is not smaller than 6 and is not larger than 12. If the RE mapping location is overlapped with the middle of the frequency band, a frequency offset(Δf) is added/multiplied to the modulated sequence. Wherein the frequency offset (Δf) is equal to or larger than half of the SCS.

### First LP Signal Format3:

The first LP signal format3 is determined by at least one of a modulation scheme, FEC coding, block segmentation, transforming precoder and/or frequency hopping. The information bits are divided into a plurality of blocks. Each block is encoded by a Manchester code to generate a sequence x. Sequence x is modulated by a modulation scheme, wherein the modulation scheme includes at least one of the QPSK, BPSK, OOK, ASK and/or FSK. The modulated sequence is an amplitude sequence and is encoded by the FEC coding. The FEC coding includes at least one of polar code, TBCC, RM code and/or LDPC. The modulated sequence is truncated/padded to the specific length D before processed by the transforming precoder. In an embodiment, the specific length D is a product of the number of PRB and 12 and/or is a multiple of 6. As an alternative, the specific length D is determined by

$$⌈ \frac{S}{α} ⌉ \cdot α ,$$

where S is the length of the modulated sequence and α is an integer that is not smaller than 6 and is not larger than 12. The block with the frequency hopping may occupy the same OFDM symbol with the block without frequency hopping. If the RE mapping location is overlapped with the middle of the frequency band, a frequency offset Δf is added/multiplied to the modulated sequence. The frequency offset Δf may be equal to or larger than half of the SCS.

### First LP Signal Format 4:

The first LP signal format4 is determined by at least one of a sequence, time spreading, repetition and/or frequency hopping. The information bits are modulated by sequence. The modulated sequence is truncated/padded to the specific length D before processed by transforming precoder. In an embodiment, the specific length D is a product of the number of PRB and 12 and/or is a multiple of 6. As an alternative, the specific length D is determined by

$$⌈ \frac{S}{α} ⌉ \cdot α ,$$

where S is the length of the modulated sequence and α is an integer that is not smaller than 6 and is not larger than 12. The block with the frequency hopping can occupies the different OFDM symbol with the block without the frequency hopping. The block with different frequency hopping can support a number of repetitions in a number of OFDM symbols. If the RE mapping location is overlapped with the middle of the frequency band, a frequency offset Δf is added/multiplied to the modulated sequence. The frequency offset Δf may be equal to or larger than half of the SCS. In an embodiment, the length of the sequence of LP signal format 4 is not larger than that of the sequence of the LP signal format 0.
First LP signal format 5. The first LP signal format 5 is determined by at least one of a modulation scheme, a sequence, FEC coding, time spreading, repetition and/or frequency hopping. The information bits are divided into two parts. The first part of information bits is modulated by OOK/ASK to generate a sequence 1. The second part of the information bits is spread/repeated and/or modulated by π/2-BPSK/QPSK/sequence/16QAM (Quadrature Amplitude Modulation) to generate a sequence 2. The modulated sequence 1 is truncated/padded to the specific length D before processed by the transforming precoder. In an embodiment, the specific length D is a product of the number of PRB and 12 and/or is a multiple of 6. As an alternative, the specific length D is determined by

$$⌈ \frac{S}{α} ⌉ \cdot α ,$$

where S is the length of the modulated sequence and α is an integer that is not smaller than 6 and is not larger than 12. In an embodiment, the length of sequence 1 is a multiple of the length of the sequence 2. The sequence2 is scrambled/multiplied/added with modulo 2 with a part of the sequence 1, wherein the length/location of the part of sequence1 is determined according to the code rate of the Manchester code, the length of spreading sequence, the length of the sequence 2, the number of ones (‘1’) of the sequence 1, the number of information bits carried by the sequence 2 and/or the number of information bits carried by sequence1. Wherein the first part of information bits can be divided into a plurality of blocks. The block with the processing procedure as sequence1 and/or sequence 2 supports repetition and/or hopping in different OFDM symbols. The block with the frequency hopping can occupies the different OFDM symbol with the block without the frequency hopping. The block with different frequency hopping can support a number of repetitions in a number of OFDM symbols. If the RE mapping location is overlapped with the middle of the frequency band, a frequency offset Δf is added/multiplied to the modulated sequence. The frequency offset Δf may be equal to or larger than half of the SCS. In an embodiment, the length of the sequence of LP signal format 5 is not larger than that of the sequence of the LP signal format 0.

In an embodiment, a generation procedure of the first LP signal format 5 includes at least one of the following steps:
a) M continuous OOK symbols carry M bits information S_{M}. Define S_{M}=[s₀, s₁, s₂, s₃ . . . , s_{M-1}];
b) each sequences carry N bits information S_{N}. Define S_{N}=[s₀, s₁, s₂ s₃ . . . , s_{N-1}].
c) transform S_{M} into Q_{K} according to the formula disclosed in the description part. Wherein the length of Q_{K} is equal to K;
d) transform S_{N} into Q_{L} according to the following formula. Wherein the length of Q_{L} is equal to L;
In some embodiments,

$${Q}_{L} = [ {r}_{0}^{x} , {r}_{1}^{x} , … , {r}_{l - 1}^{x} ]$$

if the number of candidate sequences is not larger than 2^{N}, wherein x represents the x-th sequence or x-th triggering state or x-th code point or x-th indication information of N-bit state, e.g. first represents the first sequence and ‘00’ indication information of 2-bit state. Wherein L=l. In some embodiments,

$${Q}_{L} = [ {r}_{0}^{x 0} , {r}_{1}^{x 0} , … , {r}_{l - 1}^{, x 0} , {r}_{0}^{x 1} , {r}_{1}^{x 1} , … , {r}_{l - 1}^{x 1} , {r}_{0}^{x ( γ - 1 )} , {r}_{1}^{x ( γ - 1 )} , … , {r}_{l - 1}^{x ( γ - 1 )} ]$$

if each l-length symbols can indicate

$$\frac{N}{γ}$$

bits information. Wherein L=y·l.
e) Process Q_{K} by K point DFT/FFT to obtain sequence/data D_{K}=[d₀, d₁, d₂, d₃, . . . , d_{K-1}];
f) Process Q_{L} by l point DFT/FFT to obtain sequence/data D_{L}=[d₀, d₁, d₂, d₃, . . . , d_{L-1}];
g) multiply a first part of D_{K} with a first part of D_{L} to generate the first part of F_{K} according to the following formula.

$${F}_{K}^{1} = [ {d}_{0}^{K 1 ′} \cdot {d}_{0}^{L 1 ′} , {d}_{1}^{K 1 ′} \cdot {d}_{1}^{L 1 ′} , … , {d}_{l - 1}^{K 1 ′} \cdot {d}_{l - 1}^{L 1 ′} ] ,$$

$$wherein$$

$${D}_{K}^{K 1 ′} = [ {d}_{0}^{K 1 ′} , {d}_{1}^{K 1 ′} , … , {d}_{l - 1}^{K 1 ′} ] ,$$

$${D}_{L}^{L 1 ′} = [ {d}_{0}^{L 1 ′} , {d}_{1}^{L 1 ′} , … , {d}_{l - 1}^{L 1 ′} ]$$

wherein the

$${D}_{K}^{K 1 ′}$$

is a first part of D_{K}. Wherein

$${D}_{L}^{L 1 ′}$$

is the first part of D_{L}. Wherein D_{K} comprises at least one of

$${D}_{K}^{K 1 ′} , {D}_{K}^{K 2 ′} , … , and {D}_{K}^{KM ′} .$$

Wherein the length

$${D}_{K}^{K 1 ′} and {D}_{L}^{L 1 ′}$$

is equal to l. Wherein

$$\frac{K}{M * l}$$

is equal to the value of code rate or spreading code length for OOK modulation symbol generation. Wherein the F_{K} comprises the part of the

$$[ {F}_{K}^{1} , … , {F}_{K}^{M} ]$$

and the part of

$$[ {D}_{K}^{Z 1 ′} , … , {D}_{K}^{ZM ′} ] .$$

wherein

$${D}_{K}^{Zi ′}$$

is the part that is not multiplied by

$${D}_{L}^{Li ′}$$

and is immediately behind the

$${D}_{K}^{K 1 ′} .$$

h) Map sequence/data F_{K} into the K subcarriers in the frequence domain resource for LP-WUS transmission.
i) When the system frequency band includes B subcarriers, fill data into B subcarriers and perform B point IDFT/IFFT process, then obtain time domain data T_{B}=[t₀, t₁, t₂, t₃, . . . , t_{B-1}]. wherein T_{B}=[t₀, t₁, t₂, t₃, . . . , t_{B-1}] is M OOK time domain symbols scrambled/multiplied by at least M sequences which is a sampled data. Wherein [t₀, t₁, t₂, t₃, . . . , t_{B/M-1}] is the first OOK symbol of the M OOK symbols scrambled/multiplied by a sequence. It is easy to obtain the information carried by the sequence by detecting the sequence with a sequence correlation method. It is easy to obtain the information carried by OOK symbol based on threshold or sequence correlation method.

In the present disclosure, the use of series numbers including {1), 2), 3), . . . , etc.} or {a), b), . . . , z)} does not represent or provide any sequential information and does not represent ranking/ordering the content/step of each bullet.

In an embodiment, the first LP signal format 1, 3 and/or 4 is used to provide a larger coverage.

In an embodiment, the format of the LP signal is determined according to the indication information set of the LP signal, the processing steps to generate the LP signal, the resource set ID and/or the set of candidate sequence configured by SIB or RRC signaling. The processing steps include at least one of the modulation scheme, the FEC coding, block segmentation, frequency segmentation, the frequency hopping, the spreading, the OCC, DFT transformation, the transforming precoder, the frequency offset and/or the maximum number of repetitions.

FIG. 5 shows a schematic diagram of a first LP signal according to an embodiment of the present disclosure. In FIG. 5, the first LP signal occupies two OFDM symbols. The first symbol is used to transmit the first type/format of sequence and the second symbol is used to transmit the second type/format of sequence. The first type/format of sequence is configured with frequency hopping or frequency segmentation in a same OFDM symbol. Particularly, the LP signal of FIG. 5(a) shows the whole range of frequency domain resource of the first type/format of sequence (including the empty part in OFDM symbol 0) is the same as that of the second type/format of sequence. The LP signal of FIG. 5(b) shows the whole range of frequency domain resource of the first type/format of sequence is the different from that of the second type/format of sequence. The whole range of frequency domain resource of a sequence represents the number of REs started from the start of RE to the end of RE occupied by the sequence in an OFDM symbol. The LP signal of FIG. 5(a) shows that the length of the first type/format of sequence is smaller than that of the second type/format of sequence. The LP signal of FIG. 5(b) shows the length of the first type/format of sequence is the same as that of the second type/format of sequence.

In an embodiment for the first LP signal format 5, there are two parts where a first part indicates at least one of the information of the first information set and a second part indicates at least one of the information of the second and/or third and/or fourth information set. The second part is scrambled by the first part. The number of PRBs occupied by the second part is equal to or a multiple of that occupied by the first part. For example, the number of PRBs occupied by the second part is double of that occupied by the first part. The first part is processed by at least one of generating information bits, modulated by a modulation scheme and encoding by a FEC or Manchester code, polar code, TBCC, RM code, and LDPC code. The second part is processed by at least one of generating a m sequence based on an initial value and an initial sequence, multiplying a phase sequence based on the m sequence and the length of the sequence and scrambling with a part of the first part. The initial value is determined by at least one of the UE group ID, UE subgroup ID, UE ID and cell ID. The length of first sequence is the multiple of the second sequence.

In an embodiment, the resource information related to the first LP signal includes at least one of the following information/indication fields:
1) The resource set ID: The number of resource configurations related to the first LP signal in a resource set is not smaller than the number of first LP signal formats. The information of resource configuration of the first LP signal includes at least one of the followings:
2) Frequency hopping: The frequency hopping is configured to indicate that the first LP signal is hopping in/between/among different beams, in/between/among different symbols and/or in/between/among different frequency band, and/or a granularity of the frequency hopping, and/or enabling/disabling the frequency hopping. For example, the frequency hopping indicates that the first LP signal is hopping in/between/among different beams.
3) Frequency offset: The frequency offset is configured to indicate a frequency offset used to transmit the first LP signal. The frequency offset (Δf) is added/multiplied to the modulated sequence. In an embodiment, the frequency offset (Δf) is equal to or larger than half of the SCS (e.g., 7.5 KHz, 15 KHz and/or 30 KHz).
4) Zero DC: The Zero DC is configured to indicate whether to set or not to set the DC/middle of a frequency band as zero, wherein the frequency band is allocated for the first LP signal transmission.

In an embodiment, the frequency offset and the zero DC are used to improve the link level performance for the detection/reception of the first LP signal at the UE side.

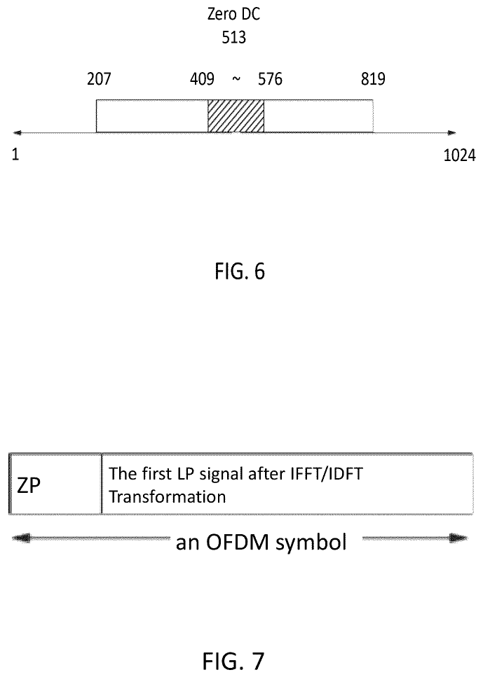

FIG. 6 shows a schematic diagram of a frequency band according to an embodiment of the present disclosure. In FIG. 6, the first LP signal is located in the middle of the frequency band and overlaps the DC location. The length of first LP signal is 127 REs, and the DC is set to zero. Therefore, the LP signal is mapped to the REs with the index 243˜305 and 307˜370 in the frequency band for the first LP signal transmission.
5) The start frequency location. It indicates the start frequency location/the start RB index/a reference point relative to CRB0, DC and/or the middle of BWP allocated for the first LP signal.
6) The frequency of the first LP signal, it indicates the frequency of the first LP signal or the first LP signal associated to the detection of the second LP signal. The value of the field of the frequency of the first LP signal is a k*SCS Hz shift from the sync raster or the raster of the detection of the second LP signal.
7) Format of the first LP signal
8) First symbol that the first LP signal is transmitted
9) Duration for the detection of the first LP signal
10) PRB offset: The PRB offset indicates an offset to the start of PRB (index).
11) Staring PRB index: The Staring PRB index indicates the starting PRB index of the frequency resource allocated for the first LP signal or the starting PRB index of the frequency resource allocated for the first and/or the second frequency hopping.

For example, the number of hops for the first LP signal transmission includes at least 1, 2, 3 and 4. The SCS gap between adjacent hops includes at least 0, 6, 8, 12, 24, 36 and the length of the sequence or the length of the sequence plus 1. If the information bits are modulated by at least one of ZC sequence, PN sequence, m sequence and SSS sequence, there is a zero or empty mapping location located in the middle of the modulated sequence in the frequency domain.
12) The OFDM symbol: The OFDM symbol is configured to indicate the OFDM symbol ID/the number of OFDM symbols/time domain resource allocated for the first LP signal. The time-continuous first LP signal includes at least one of a zero cyclic prefix (ZP), and/or the first LP signal after N-point IFFT/IDFT (inverse fast Fourier transform/inverse discrete Fourier transform) transformation. The length of ZP is equal to the length of cyclic prefix (CP) according to the configuration of SCS, band width, sample rate and the OFDM symbol ID, and/or is determined based on the length of each block or segmentation, the number of blocks or segments, the configuration of SCS, band width, sample rate and the OFDM symbol ID. In an embodiment, the ZP is added to each block/each frequency segment/each OFDM symbol where the first LP signal is transmitted.

FIG. 7 shows a schematic diagram of an OFDM symbol according to an embodiment of the present disclosure. In FIG. 7, the OFDM symbol carrying the first LP signal is consisted of a ZP and the first LP signal after the IFFT/IDFT transformation. In this embodiment, it is assumed that the SCS=30 KHz, BW=20 MHz and the number of IFFT point=1024. The ZP includes a length of zeros. The length of ZP is equal to 88 or 72. The length of the first LP signal after IFFT/IDFT transmission is equal to 1024.

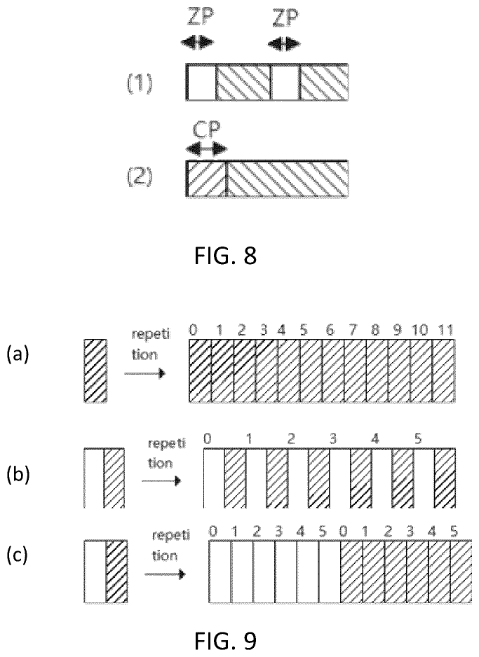

FIG. 8 shows a schematic diagram of OFDM symbols according to an embodiment of the present disclosure. FIG. 8 shows (1) the OFDM symbols of the first LP signal with two blocks/segments and two ZPs and (2) DL signal with CP. The length of ZP is determined by the function(P*L), wherein β is a factor that is not larger than ½ and L is the length of each block/segment LP signal or the length of CP and/or is determined by the total number of REs allocated for the first LP signal or each block/frequency segmentation of the first LP signal. In an embodiment, the length of ZP is not less than 1 RE.

In an embodiment, the time-continuous signal on antenna port p and subcarrier spacing configuration μ for OFDM symbol

$$l ∈ \{ 0 , 1 , … , {N}_{slot}^{subframe , μ} {N}_{symb}^{slot} - 1 \}$$

in a subframe for first LP signal with one ZP is defined by the following formulas. Wherein the first LP signal includes one segment in frequency domain.

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix}$$

$${\overline{s}}_{l}^{( p , μ )} ( t ) = {\sum }_{k = 0}^{{N}_{ℊ rid , x}^{size , μ} {N}_{SC}^{RB} - 1} {a}_{k , l}^{( p , u )} {e}^{j2π ( k + {k}_{0}^{μ} - {N}_{ℊ rid , x}^{size , μ} {N}_{SC}^{RB} / 2 ) Δ f ( t - {N}_{ZP , l}^{μ} {T}_{c} - {t}_{start , l}^{μ} )}$$

$${k}_{0}^{μ} = ( {N}_{ℊ rid , x}^{size , μ} + {N}_{ℊ rid , x}^{size , μ} / 2 ) {N}_{SC}^{RB} - ( {N}_{ℊ rid , x}^{size , {μ}_{0}} + {N}_{ℊ rid , x}^{size , {μ}_{0}} / 2 ) {N}_{SC}^{RB} {2}^{{μ}_{0} - μ}$$

$${T}_{symb , l}^{μ} = ( {N}_{u}^{μ} + {N}_{ZP , l}^{μ} ) {T}_{c}$$

Where t=0 at the start of the subframe,

$${N}_{u}^{μ} = {N}_{IFFT} \cdot {2}^{- μ}$$

$${N}_{ZP , l}^{μ} = \{ \begin{matrix}\frac{1}{4} {N}_{IFFT} \cdot {2}^{- μ} or 512 τ \cdot {2}^{- μ} & extended cyclic prefix \\ 144 τ \cdot {2}^{- μ} + 16 τ & normal cyclic prefix , l = 0 or l = 7 \cdot {2}^{μ} \\ 144 τ \cdot {2}^{- μ} & normal cyclic prefix , l \neq 0 or l \neq 7 \cdot {2}^{μ}\end{matrix}$$

wherein r represents the unit of/one SCS or sampling point.

In an embodiment, the time-continuous signal on antenna port p and subcarrier spacing configuration μ for OFDM symbol

$$l ∈ \{ 0 , 1 , … , {N}_{slot}^{subframe , μ} {N}_{symb}^{slot} - 1 \}$$

in a subframe for first LP signal with M ZP is defined by the following formulas. Wherein the first LP signal includes M segments in frequency domain. Wherein the length of ZP is equal to function

$$( \frac{1}{M} * {N}_{CP , l}^{μ} ) .$$

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix}$$

$${\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - M \cdot {N}_{ZP , l}^{μ} {T}_{c} - {t}_{start , l}^{μ} )}$$

$${k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ}$$

$${T}_{symb , l}^{μ} = ( {N}_{u}^{μ} + M \cdot {N}_{ZP , l}^{μ} ) {T}_{c}$$

$$Where t = 0 at the start of the subframe ,$$

$${N}_{u}^{μ} = {N}_{IFFT} \cdot {2}^{- μ}$$

$${N}_{ZP , l}^{μ} = \{ \begin{matrix}\frac{1}{4 \cdot M} {N}_{IFFT} \cdot {2}^{- μ} or \frac{512}{M} τ \cdot {2}^{- μ} & extended cyclic prefix \\ \frac{144}{M} τ \cdot {2}^{- μ} + 16 τ & normal cyclic prefix , l = 0 or l = 7 \cdot {2}^{μ} \\ \frac{144}{M} τ \cdot {2}^{- μ} & normal cyclic prefix , l \neq 0 or l \neq 7 \cdot {2}^{μ}\end{matrix}$$

wherein τ represents the unit of/one SCS or sampling point.

In an embodiment, the time-continuous signal on antenna port p and subcarrier spacing configuration for OFDM symbol

$$l ∈ \{ 0 , 1 , … , {N}_{slot}^{subframe , μ} {N}_{symb}^{slot} - 1 \}$$

in a subframe for first LP signal is defined by the following formulas. Wherein the first LP signal for OFDM symbol l includes M segment in frequency domain and each segment has a ZP. Wherein the ZP is located between two segments in time domain and/or is located immediately before the corresponding time domain segment. Wherein the length of ZP is equal to the

$$δ \cdot {T}_{symb , l , n}^{μ} .$$

Wherein δ is in the range of (0,1) and is predefined or configured by higher layer parameter.

$${s}_{l}^{( p , μ )} ( t ) = \{ \begin{matrix}{\overline{s}}_{l , m}^{( p , μ )} ( {t}_{m} ) & {t}_{start , l}^{μ} + {\sum }_{n = 0}^{m - 1} {T}_{symb , l , n}^{μ} \leq {t}_{m} < {t}_{start , l}^{μ} + {\sum }_{n = 0}^{m} {T}_{symb , l , n}^{μ} \\ 0 & otherwise\end{matrix} , m ∈ \{ 0 , … , M - 1 \}$$

$${\overline{s}}_{l , m}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - {N}_{ZP , l , m}^{μ} {T}_{c} - {t}_{start , l}^{μ} - {\sum }_{n = 0}^{m} {T}_{symb , l , n}^{μ} )}$$

$${k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ}$$

### Wherein

$${T}_{symb , l , n}^{μ}$$

is the time duration of the time-continuous n-th segment in OFDM symbol l.

$${T}_{symb , l , n}^{μ} = ( {N}_{u , n}^{μ} + {N}_{ZP , l , n}^{μ} ) {T}_{c}$$

Where t=0 at the start of the subframe,

$${N}_{u , n}^{μ} = \frac{{N}_{IFFT}}{M} \cdot {2}^{- μ} or {N}_{u , n}^{μ} = {N}_{DFT} \cdot {2}^{- μ} {N}_{u , n}^{μ} = {L}_{m}^{μ} \cdot τ \cdot {2}^{- μ} ,$$

wherein

$${L}_{m}^{μ}$$

is the number of REs occupied by one segment in frequency domain. Wherein N_{DFT} is the number of DFT point before the segment mapping to REs. In some embodiments,

$${L}_{m}^{μ} \geq {N}_{DFT} .$$

$${N}_{ZP , l}^{μ} = \{ \begin{matrix}\frac{32}{9} δ \cdot {T}_{symb , l , n}^{μ} & extended cyclic prefix \\ δ \cdot {T}_{symb , l , n}^{μ} + δ \cdot 16 τ & normal cyclic prefix , l = 0 or l = 7 \cdot {2}^{μ} \\ δ \cdot {T}_{symb , l , n}^{μ} & normal cyclic prefix , l \neq 0 or l \neq 7 \cdot {2}^{μ}\end{matrix}$$

wherein τ represents the unit of/one SCS or sampling point.
13) The number of PRBs. It indicates the number of PRBs allocated for the first LP signal. The number of PRBs is the multiple of P (which is used to determine the length of ZP) and/or is evenly divisible by p, and/or is the multiple of 2, 3, 4 and/or 6.
14) a cyclic shift index set
15) a UE group ID or a UE subgroup ID used to determine the initial value of the sequence generation
16) multi-symbol transmission for the first LP signal that indicates the first LP signal is transmitted in multiple symbols
17) repetition mode of the first LP signal, it includes at least one of the maximum number of repetition number, the repetition mode index, the start symbol ID of each repetition and the cross-slot repetition indicator.

FIG. 9 shows schematic diagrams of repetition modes according to an embodiment of the present disclosure. In this embodiment, the UE is provided with a repetition mode of the first LP signal. FIG. 9(a) shows a first repetition mode used for the one-symbol first LP signal. The one-symbol first LP signal refers to the first LP signal carrying the total of information bits is transmitted in one OFDM symbol. Based on the first repetition mode, the one-symbol first LP signal repeats in a number of symbols. As shown in FIG. 9(a), the one-symbol first LP signal is repeated during a number of continuous symbols.

FIG. 9(b)(c) show two types of a second repetition mode used for the multiple-symbol first LP signal. The multiple-symbol first LP signal refers to the first LP signal carrying the total of information bits is transmitted in more than one OFDM symbol. For example, if the first LP signal has 8 information bits and the first LP signal indicates 2 information bits in one OFDM symbol, the transmission of the 8 information bits needs at least 4 OFDM symbols. In FIG. 9(b)(c), the multiple-symbol first LP signal repeats in a number of continuous/contiguous symbols. Note that, each symbol of first LP signal is denoted as a block. For the first type of repetition method, the first LP signal is repeated per transport block/whole symbol. As shown in FIG. 9(b), the raw information bits are transmitted in 2 symbols. The first LP signal is repeated per 2 symbols and the repetition number is 6. For the second type of repetition method, the first LP signal is repeated per block/symbol. As shown in FIG. 9(c), the raw information bits are transmitted in 2 symbols and the first LP signal is repeated per block and the repetition number is 6.

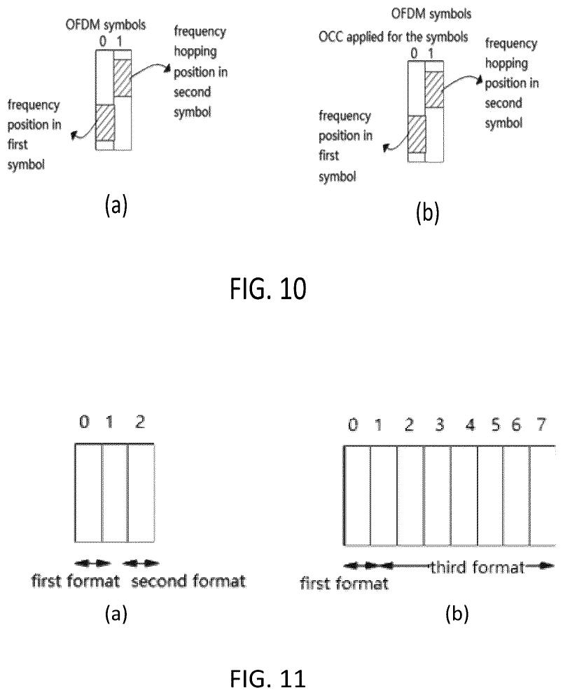

FIG. 10 shows schematic diagrams of hopping modes according to an embodiment of the present disclosure. In FIG. 10(a), the UE is provided with a hopping mode of the first LP signal. This hopping mode includes different frequency domain hopping positions in OFDM symbols occupied by the first LP signal. In FIG. 10(b), the UE is provided with another hopping mode of the first LP signal. This hopping mode includes different frequency domain hopping positions in OFDM symbols occupied by the first LP signal and OCC applied for the sequence among OFDM symbols occupied by the first LP signal. The length of the sequence is not larger than 144.
18) Interleaving indication: The interleaving indication indicates whether to interleave the first LP signal in frequency domain or in time domain or not.
19) Truncation indication: The truncation indication indicates whether to truncate the encoded/modulated sequence or not.
20) The number of information bits or the bit size carried by the first LP signal

FIG. 11 shows schematic diagrams of the first LP signal according to embodiments of the present disclosure. In the embodiment of FIG. 11(a), the first LP signal is transmitted in 2 OFDM symbols and is configured with no repetition. The first OFDM symbol is occupied by the first format of the first LP signal. and the second OFDM symbol is occupied by the second format of the first LP signal. The first format indicates 2 bits in the OFDM symbol 0 and the second format indicates 4 bits in OFDM symbol 2. The length of the sequence between the first format and the second format is different. The frequency domain resource/the number of PRBs occupied by the first format is smaller than that occupied by the second format.

In the embodiment of FIG. 11(b), the first LP signal is transmitted in 8 OFDM symbols and is configured with no repetition. The first OFDM symbol is occupied by the first format of the first LP signal carrying 2 raw information bits, and the remaining 7 OFDM symbols are occupied by the third format of the first LP signal carrying 14 raw information bits. The first format indicates the first type of indication information and the third format indicates the third type of indication information. The first type of indication information and the third type of indication information are different types of indication information and comprise a part of the indication information of the first LP signal.
20) Interval of the start frequency location/subcarrier between the prestored sequence and the first LP signal.

For example, a phase sequence is generated by

$${e}^{j \frac{2 π}{N} n \cdot m} ,$$

where N is the number of IFFT/IDFT points (e.g., 1024 or 2048), n is an integer that is in the range of [0, N−1], m is the frequency offset or the interval of the start frequency location/subcarriers between the prestored sequence and the first LP signal, and the frequency offset or the interval of the start frequency location/subcarriers is configured by a higher layer parameter. In an embodiment, m is larger than 0 if the start of frequency location/subcarrier index/RB index of the transmitted first LP signal is right-shifted or higher/larger than that of the transmitted first LP signal in the frequency band or the frequency domain and m is smaller than 0 if the start of frequency location/subcarrier index/RB index of the transmitted first LP signal is left-shifted or lower/smaller than that of the transmitted first LP signal in the frequency band or the frequency domain. The UE may also determine the start of the frequency location of the first LP signal according to the value of m and the start frequency location of the prestored sequence/the prestored first LP signal.

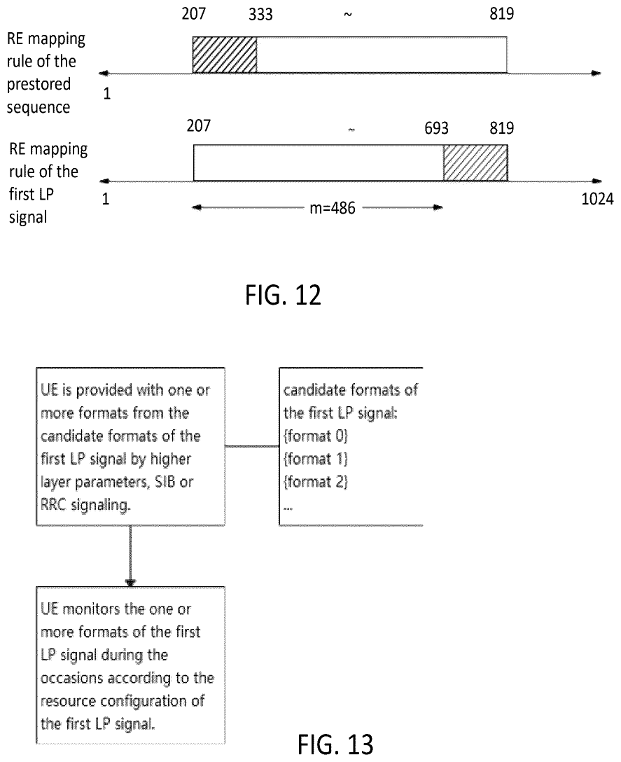

FIG. 12 shows a schematic diagram of mapping rules of the prestored sequence and the first LP signal according to an embodiment of the present disclosure. In FIG. 12, the prestored sequence/the prestored first LP signal is located in the start of the frequency band and the first LP signal transmitted by BS is located in the end of the frequency band. When/if the UE detects the first LP signal transmitted by the BS, the UE modifies the prestored sequence/the prestored first LP signal based on the frequency offset or the interval of the start frequency location/subcarriers between the prestored sequence or the prestored first LP signal in time domain and the first LP signal. In this embodiment, the UE modifies the prestored sequence by multiplying the

$${e}^{j \frac{2 π}{N} n \cdot m} ,$$

wherein N=1024, m=486, and n=0˜1023.

In an embodiment, the BS configures one or more formats of the first LP signal from the candidates of formats of the first LP signal by higher layer parameters, SIB or RRC signaling. The UE monitors the one or more formats of the first LP signal during the occasions for the detection of the first LP signal.

FIG. 13 shows a flowchart of a method according to an embodiment of the present disclosure. The method shown in FIG. 13 may be used for the first LP signal monitoring. Specifically, the UE is provided with one or more (candidate) formats of the first LP signal, e.g., via the higher layer parameters, SIB or RRC signaling. In this embodiment, the provided (candidate) formats of the first LP signal comprises format 0, format 1, format 2, . . . , etc. The UE monitors the provided one or more (candidate) formats of the first LP signal during the occasions according to the resource configuration of the first LP signal.

In an embodiment, the fourth format of the first LP signal includes a first part and a second part. The first part is an SSS sequence multiplying with a phase sequence. The phase sequence is generated according to:

$${θ}_{{n}_{f} , {n}_{s}} ( {m}^{′} ) = \{ \begin{matrix}1 & if {c}_{{n}_{f} , {n}_{s}} ( 2 {m}^{′} ) = 0 and {c}_{{n}_{f} , {n}_{s}} ( 2 {m}^{′} + 1 ) = 0 \\ - 1 & if {c}_{{n}_{f} , {n}_{s}} ( 2 {m}^{′} ) = 0 and {c}_{{n}_{f} , {n}_{s}} ( 2 {m}^{′} + 1 ) = 1 \\ j & if {c}_{{n}_{f} , {n}_{s}} ( 2 {m}^{′} ) = 1 and {c}_{{n}_{f} , {n}_{s}} ( 2 {m}^{′} + 1 ) = 0 \\ - j & if {c}_{{n}_{f} , {n}_{s}} ( 2 {m}^{′} ) = 1 and {c}_{{n}_{f} , {n}_{s}} ( 2 {m}^{′} + 1 ) = 1\end{matrix} ,$$

wherein m′ corresponds to each order number/element of the phase sequence, Cₙ_{_{f}}_{,n}_{ₛ}(i) is a scrambling sequence. The initial value of the scrambling sequence is determined by at least one of the time/frequency domain resource ID, the cell ID, the paging occasion index and the frame ID. The first LP signal is generated by multiplying/dividing/scrambling/replacing/adding the first part with the second part.

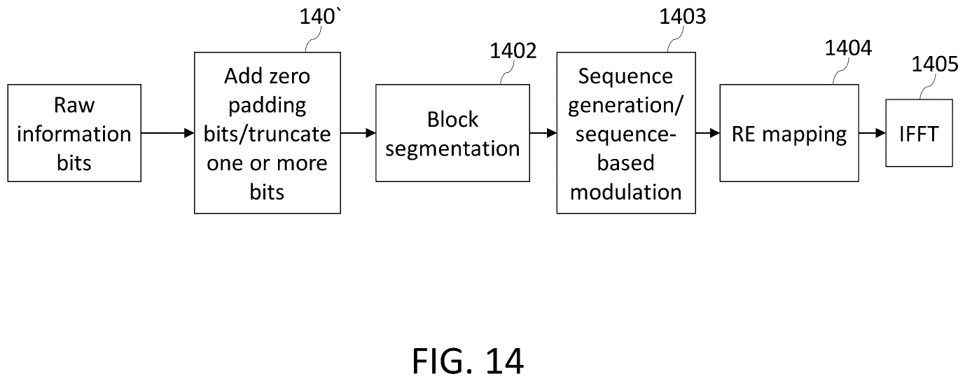

FIG. 14 shows a flowchart of a procedure according to an embodiment of the present disclosure. The procedure shown in FIG. 14 is used for a transmission of the first format of the first LP signal. Specifically, in this embodiment, the raw information (bits) is denoted as m, wherein m includes the first type of indication information of LP signal.

Step 1401: The raw information (bits) may be added padding bits or truncated to M ((=[m₀, m₁, m₂, m₃, . . . , mₙ₋₁]) to satisfy a condition. The condition includes at least one of the DFT-s-OFDM transformation, the number of indication information bits can be divisible by the number of segmented blocks (denoted as C). In an embodiment, M has the length that can be divisible by at least one of 2, 3, 6 and 8.

Step 1402: M is segmented as a number of blocks (e.g., C blocks). Each block carries p=function(M/C) information bits, wherein M=[S⁰, . . . , S^{C-1}], wherein Sⁱ=[s₀, . . . , sₚ₋₁] and function( ) represents a function of rounding, rounding down, rounding up or retaining the input variable.

Step 1403: For a block, the information bits of the block are modulated by the OOK, the ASK, or the FSK to generate modulated sequence O. For OOK modulation, O=[s₀, s₀, . . . , s₀, s₁, s₁, . . . , s₁, . . . , sₚ₋₁, sₚ₋₁, . . . , sₚ₋₁]. The number of continuous sⱼ is equal to L and the length of the modulated sequence 0 is equal to p*L, wherein L is equal to the length of the sequence (or the length of the sequence plus 1) used for scrambling/multiplying/modulo 2 plus operation with each part of continuous sⱼ, or O and O is an amplitude sequence or a binary bit sequence.

Step 1404: Using a sequence (denoted as T) to multiply each part of continuous sⱼ of the modulated sequence O to generate the sequence Q. Wherein the length of Q is equal to the length of the modulated sequence O or half of the length of the modulated sequence O. Q=[T⁰, . . . , T^{p-1}], wherein Tⁱ=[t₀, . . . , t_{L-1}] and T is at least one of a ZC sequence, a m sequence, an SSS, a PN sequence, a QPSK or a 16QAM sequence. In an embodiment, the sequence may indicate the second type of indication information of LP signal.

Step 1405: Mapping Q into the frequency domain RE mapping location, wherein the frequency domain RE mapping location is configured by the higher layer parameter.

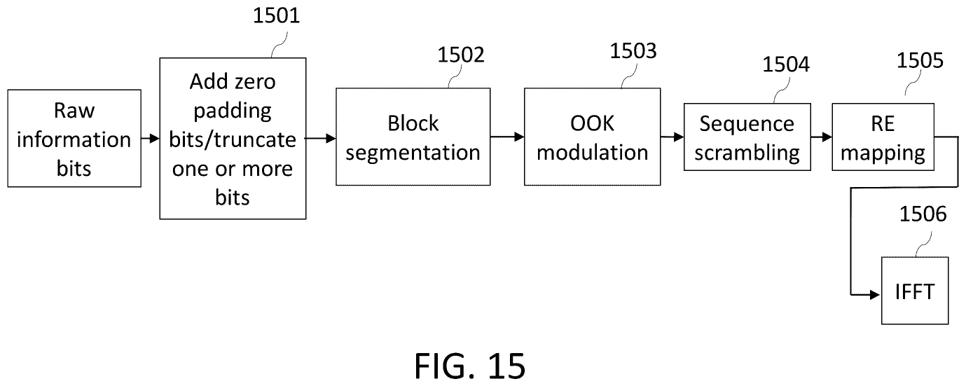

FIG. 15 shows a flowchart of a procedure according to an embodiment of the present disclosure. The procedure shown in FIG. 15 is used for a transmission of the fourth format of the first LP signal. Specifically, in this embodiment, the raw information (bits) is denoted as m, wherein m includes the first type of indication information of LP signal.

Step 1501: The raw information (bits) may be added padding bits or truncated to M ((=[m₀, m₁, m₂, m₃, . . . , mₙ₋₁]) to satisfy a condition. The condition includes at least one of the DFT-s-OFDM transformation, the number of indication information bits can be divisible by the number of segmented blocks (denoted as C). In an embodiment, M has the length that can be divisible by at least one of 2, 3, 6 and 8.

Step 1502: M is segmented as a number of blocks (e.g., C blocks). Each block carries p=function(M/C) information bits, wherein M=[S⁰, . . . , S^{C-1}], wherein Sⁱ=[S₀, . . . , sₚ₋₁] and function( ) represents a function of rounding, rounding down, rounding up or retaining the input variable.

Step 1503: For a block, the information bits of the block are modulated by the OOK, the ASK, or the FSK to generate modulated sequence O. For OOK modulation, O=[S₀, S₀, . . . , S₀, S₁, S₁, . . . , S₁, . . . , Sₚ₋₁, Sₚ₋₁, . . . , Sₚ₋₁]. The number of continuous sⱼ is equal to L and the length of the modulated sequence O is equal to p*L, wherein L is equal to the length of the sequence (or the length of the sequence plus 1) used for scrambling/multiplying/modulo 2 plus operation with each part of continuous Sj, or O and O is an amplitude sequence or a binary bit sequence.

Step 1504: Encoding the sequence O as the Z by Manchester code, wherein Z=[Z₀, Z₀, . . . , Z₀, Z₁, Z₁, . . . , Z₁, . . . , Zₚ₋₁, Zₚ₋₁, . . . , Zₚ₋₁] and each zₓ is a code word

Step 1505: Using a sequence (denoted as T) to multiply each part of continuous sⱼ of the modulated sequence O to generate the sequence Q. Wherein the length of Q is equal to the length of the modulated sequence O or half of the length of the modulated sequence O. Q=[T⁰, T^{p-1}], wherein Ti=[t₀, . . . , t_{L-1}] and T is at least one of a ZC sequence, a m sequence, an SSS, a PN sequence, a QPSK or a 16QAM sequence. In an embodiment, the sequence may indicate the second type of indication information of LP signal.

Step 1506: Mapping Q into the frequency domain RE mapping location, wherein the frequency domain RE mapping location is configured by the higher layer parameter.

In an embodiment, the fourth format of the first LP signal includes a first part and a second part. The first part is an SSS sequence. The second part is a sequence generated by the raw information bits with OOK modulation scheme. The first part is used to indicate the UE group ID or cell ID, the second part is used to indicate wake-up to PDCCH monitoring. The first LP signal occupies one OFDM symbol and the number of PRBs that is not larger than 20. The number of raw information bits indicated by the first LP signal is not larger than 10. In an embodiment, the first LP signal can also be repeated in time domain, e.g., repeated within a number of slots (e.g., 4 to 14 symbols per slot), to improve the coverage of the first LP signal.

In an embodiment, the first LP signal which is consist of the first and the second part is not transmitted at the same occasions or the same time window with different formats of the first LP signal. In this embodiment, the length of the time window is not larger than the maximum number of symbols for the repetition of the first LP signal and/or the application delay.

In an embodiment, the first LP signal is processed by at least one of the procedures: OOK modulation scheme, and/or FSK modulation scheme, BPSK, pi/2 BPSK, QPSK, 16QAM, 64QAM, and/or a scrambling method by a sequence, and/or a transforming precoding method, and/or a spreading operation, and/or repetition in frequency/time domain, and/or frequency hopping, and/or interleaving operation.

In an embodiment, the second LP signal includes at least one of the SSB, the PSS sequence, the SSS sequence, the m sequence and/or the PN sequence.

In an embodiment, the indication information indicated by or comprised in the second LP signal includes at least one of the following information and/or indication fields:
a. Cell ID
b. UE-group, UE-subgroup or UE-ID
c. Wake-up to PDCCH monitoring
d. Activation/deactivation of LP signal monitoring

The configuration information associated with the second LP signal includes at least one of the followings information and/or indication fields:
1) Measurement period: the measurement period indicates the period to perform measurement based on the second LP signal.

In an embodiment, the second LP signal may be/comprise a part of the SSB. The time domain positions of the transmitted first/second LP signals (i.e., the SSS/PSS/SS blocks) in the periodicity have SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

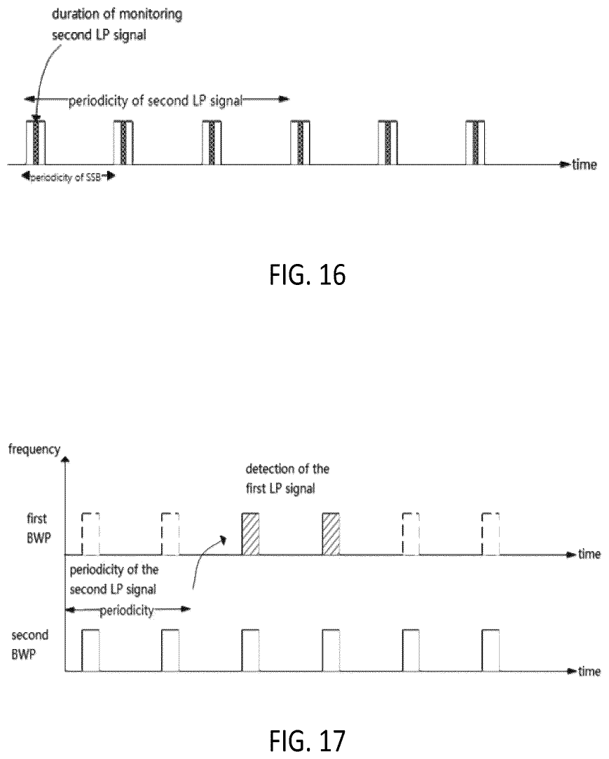

FIG. 16 shows a schematic diagram of the measurement period according to an embodiment of the present disclosure. In FIG. 16, the SSS of the SSB is used as the second LP signal. The periodicity of the second LP signal is three times of that of the SSB. According to the duration of monitoring the second LP signal, the UE monitors the SSS of the first SSB during the periodicity of the second LP signal.

In an embodiment, the measurement period is the periodicity of the second LP signal. The UE detects the second LP signal during a period which is determined by the configuration of the Measurement period field. In an embodiment, the value of the field is not smaller than 160 ms. The value of the field is configured by the information element of ‘Periodicity’ for SSB-based/CSI-RS-based measurement. For example, the periodicity is given in the number of subframes.

FIG. 17 shows a schematic diagram of the measurement period according to an embodiment of the present disclosure. In FIG. 17, the second LP signal is a part of SSB and the periodicity for the detection of the second LP signal is not smaller than that for the SSB. The periodicity of the second LP signal is different from that of the SSB.
2) The frequency of the second LP signal: This field indicates the frequency of the second LP signal or the second LP signal associated to the detection of the first LP signal. The value of the field of the frequency of the second LP signal is a k*SCS Hz shift from the sync raster or the raster of the detection of the first LP signal.
3) Quantity type: This field indicates the quantity that needs to be reported by the UE based on the measurement of the second LP signal. For example, the UE may need to report at least one of the following quantities: the SS-RSRP (Reference Signal Received Power of the synchronization signal), SS-RSRQ (Reference Signal Received quality of the synchronization signal) and/or SS-SINR (Signal to Interference & Noise Ratio of the synchronization signal).
4) Reference signal/sequence configuration: This field indicates the resource configuration for the reference signal/sequence configuration reported by the UE. In an embodiment, the second LP signal includes the reference signal/sequence.
5) Subcarrier spacing configuration: This field indicates the subcarrier spacing of the second signal. In an embodiment, at least one of the following values are applicable depending on the used frequency: FR1: 15 or 30 kHz, FR2-1: 120 or 240 kHz, FR2-2: 120, 480 or 960 kHz.
6) The second LP signal configuration for mobility: This field may include the nominal SSBs, the nominal second LP signals, the SSSs of the nominal SSBs, and the timing configuration. For example, the second LP signal configuration for mobility is configured by the information element of “ssb-ConfigMobility”.
7) Multiplexing mode, it indicates the multiplexing pattern between at least two of the first LP signal, the second LP signal and the SSB.

In an embodiment, there are n multiplexing patterns for the multiplexing pattern between the first LP signal and the second LP signal, wherein n is not smaller than 1 and not larger than 4. The multiplexing pattern is associated with the type of second LP signal, the type of first LP signal, the SCS configuration for the second LP signal and the first LP signal, the BWP for the second LP signal and the first LP signal.

In an embodiment, a first multiplexing pattern indicates that the first LP signal and the second LP signal is multiplexed in the same frequency domain or CORESET configuration. In addition, a frequency gap between the first LP signal and the second LP signal with the first multiplexing pattern is associated with the SCS configuration and the format of the first LP signal. In this embodiment, the frequency gap is not smaller than x*SCS, wherein x is an integer and is not smaller than 2.

In an embodiment, a second multiplexing pattern indicates that the first LP signal and the second LP signal are multiplexed in the same time domain or monitoring occasion. The first LP signal and the second LP signal with the second multiplexing pattern have different or same SCS configuration. The first LP signal and the second LP signal with the second multiplexing pattern can be configured in different BWPs.

In an embodiment, a third multiplexing pattern indicates that the first LP signal and the second LP signal is multiplexed in the same time domain and frequency domain.

In an embodiment, a fourth multiplexing pattern indicates that the first LP signal and the second LP signal are located in different time domain positions. In this embodiment, the second LP signal is detected/transmitted in a time window and the first LP signal is detected after the detection window of the second LP signal.

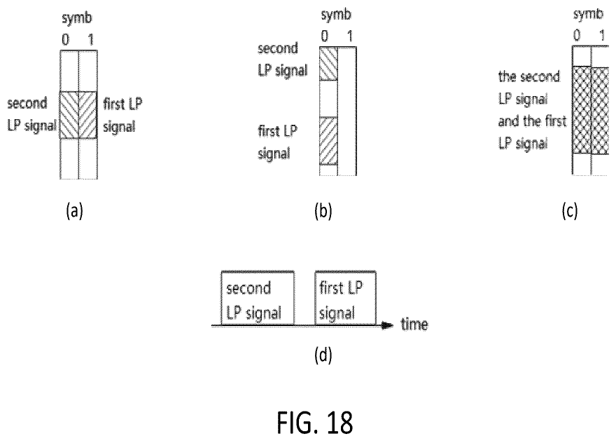

FIG. 18 shows schematic diagrams of multiplexing patterns according to embodiments of the present disclosure. FIG. 18(a) to 18(d) show embodiments respectively for the first multiplexing pattern, the second multiplexing pattern, the third multiplexing pattern and the fourth multiplexing pattern discussed in the above embodiments.

In an embodiment, for the multiplexing pattern between the first/second LP signal and the SSB, the multiplexing pattern is at least one of the multiplexing pattern between the first LP signal and the second LP signal and/or the fourth multiplexing pattern that the first/second LP signal is involved in the SSB (e.g. the first/second LP signal is the part of SSS in the SSB). For the fourth multiplexing pattern between the first/second LP signal and SSB, the periodicity for monitoring the first/second LP signal is not smaller than that for the SSB reception. The SSS in the SSB used as the first/second LP signal can indicate at least one of the indication information of the LP signal, and/or support mobility measurement for the detection of the first/second LP signal.
8) The power of the first/second LP signal: This field indicates the Average EPRE (Energy Per Resource Element) of the resources elements that carry the first/second LP signal (e.g. secondary synchronization signals) in dBm that the network used for first/second LP signal transmission.
9) The pattern of the first/second LP signal: This field indicates the type of the first/second LP signal, which includes at least one of 1) the short first/second LP signal, 2) the medium first/second LP signal, 3) the long first/second LP signal. The short/medium/long is used to express the length of the first/second LP signal or the number of symbols occupied by the first/second LP signal.
10) Location and bandwidth: This field indicates the starting PRB and the number of PRBS of the second LP signal on the special BWP or the first LP signal reception. The special BWP is used for detection of the second LP signal and/or the first LP signal. The size of the special BWP is at least one of: 1) the same size as the initial BWP for SIB1 transmission; 2) the same size as the BWP for SSB transmission; 3) the same size as the CORESET for paging reception; 4) one of 1.44 MHz, 5 MHz, 10 MHz and/or 20 MHz.

In an embodiment, the starting RB is the PRB index where the corresponding first/second LP signal resource starts in relation to CRB #0 on the common resource block grid.

In an embodiment, if the UE is provided with the first/second LP signal monitoring and the BWPs for the first LP signal reception and the second LP signal reception are different, the UE needs to switch to the special BWP for the second LP signal reception when the monitoring occasion of the second LP signal is coming after the special BWP switching delay and/or the monitoring occasion of the second LP signal is the special BWP switching delay before the monitoring occasion of the first LP signal.

In an embodiment, the special BWP is a part of the normal DL BWP (i.e., the BWP switch occurs on a single CC or on a same DL BWP in NR). Other parameter change is not involved during the special BWP switching delay. In this embodiment, the UE finishes the special BWP switch within the time duration T, wherein T is defined for the SCS configuration 15 KHz and/or 30 KHz and T is in the unit of slot/ms.

For example, the value of T is not larger than the value of the T_{BWPswitchDelay} defined in the following Table.

| | |
|---|---|
| NR Slot | BWP switch delay T_{BWPswitchDelay} (slots) |

| μ | length(ms) | Type 1Note 1 | Type 2Note 1 |
|---|---|---|---|
| 0 | 1 | 1 | 3 |
| 1 | 0.5 | 2 | 5 |
| 2 | 0.25 | 3 | 9 |
| 3 | 0.125 | 6 | 18 |
| 5 | 0.03125 | 20 | 65 |
| 6 | 0.015625 | 39 | 129 |

Note 1:
Depends on UE capability.
Note 2:
If the BWP switch involves changing of SCS, the BWP switch delay is determined by the smaller SCS between the SCS before BWP switch and the SCS after BWP switch.

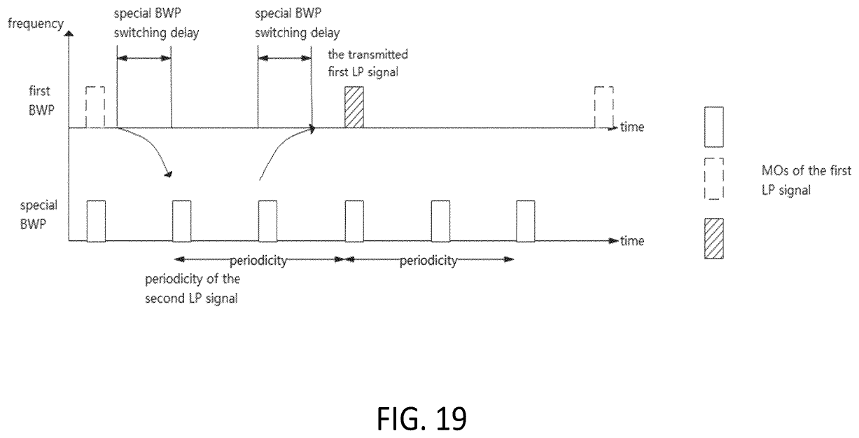

FIG. 19 shows a schematic diagram of the first LP signal and second LP signal according to an embodiment of the present disclosure. In FIG. 19, the UE switches the BWP to the special BWP after a monitoring occasion of the first LP signal or before a monitoring occasion of the first LP signal. The UE needs to finish the BWP switch from the special BWP to the first BWP before the monitoring occasion of the first LP signal. Note that the first LP signal is transmitted in the first BWP.
11) reference point: The reference point indicates the CORESET frequency reference point for the first/second LP signal or the reference point of the first/second LP signal resource. The reference point of the second LP signal can be derived according to the DL BWP id and/or subcarrier 0 of CRB0 (common resource block 0) of the reference serving cell and/or the resource configuration for the SSB. The reference point of the first LP signal can be derived according to the DL BWP id and/or subcarrier 0 of CRB0 of the reference serving cell and/or the resource configuration for the second LP signal. Wherein the reference serving cell is the cell that the UE is residing on the cell or the PCell (primary cell) or the SCell (secondary cell) or the cell that the first LP signal and/or the second LP signal is transmitted.

In the following embodiments, the relationship between the first LP signal and the second LP signal is further discussed.

In an embodiment, there is an association (relationship) between the first LP signal and the second LP signal. For example, the detection of the first LP signal or the MO of the first LP signal during a periodicity is associated with the second LP signal according to the resource configuration (by the RRC signaling). For the first LP signal transmission, there is a set of ‘S*X’ consecutive monitoring occasions (MOs). In an embodiment, ‘S’ is the number of actual transmitted the second LP signals determined according to the configuration of RRC signaling. As an alternative, S=1 and X is the number of MOs of the first LP signal associated with a second LP signal if configured by the higher layer parameter or is equal to 1 otherwise. The [x*S+K]^{th} monitoring occasion for the first LP signal transmission corresponds to the Kth transmitted second LP signal, where x=0, 1, . . . , X−1 or x=0, 1/128, 1/64, 1/32, . . . , X, K=1, 2, . . . , S. The monitoring occasions for the first LP signal which do not overlap with UL symbols are sequentially numbered from zero starting from the first monitoring occasion for the first LP signal transmission.

In an embodiment of S=1, each first LP signal is quasi co-located with the associated second LP signal. The same index is configured for the first LP signal and the second LP signal. The second LP signal is identified by the UE.

In an embodiment of S #1, every S first LP signals are quasi co-located with the same second LP signal. The S first LP signals are configured with the same index with the same second LP signal. The second LP signal is identified by the UE.

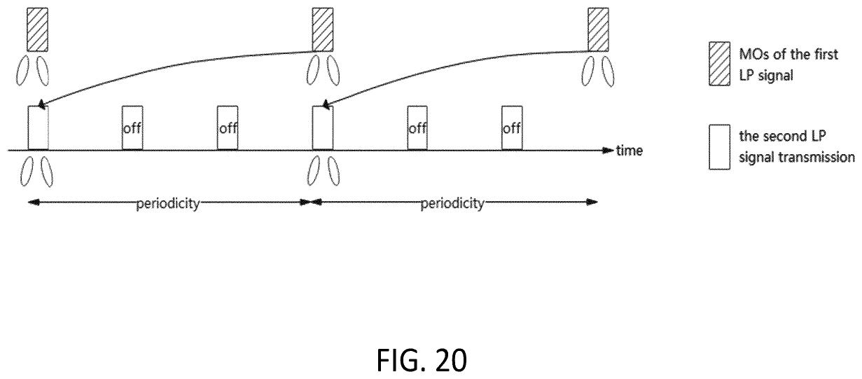

FIG. 20 shows a schematic diagram of relationship between the first LP signal and the second LP signal according to an embodiment of the present disclosure. In this embodiment, the X=1, K=1, S=1. Under such conditions, the second LP signal is transmitted only during the first occasion of the periodicity. The number of first LP signal that is associated with the second LP signal is equal to 1.

In an embodiment, the first/second LP signal may have collision with SSB. If monitoring occasions of the second LP signal is overlapped with that/those of the SSB, the UE 1) may not monitor the second LP signal during the monitoring occasions; and/or 2) may monitor the SS blocks/SSS/PSS of the SSB during the monitoring occasions. If the monitoring occasions of the first LP signal is overlapped with that/those of the SSB, the UE may not monitor the first LP signal during the monitoring occasions.

In an embodiment, the activation and/or deactivation of LP signal monitoring in a cell is indicated by at least one of a higher layer parameter, a paging PDCCH, a SIB, the second LP signal and/or a MAC CE.

In an embodiment, the higher layer parameter includes at least one of the RRC signaling, MAC (media access control) CE (control element), paging PDCCH, SSB and SIB.

In the following embodiments, the length of the sequence is assumed in the range of [23, 127].

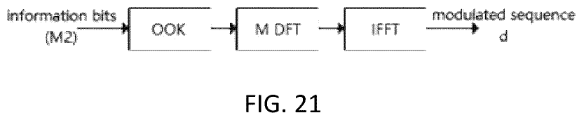

FIG. 21 shows a schematic diagram of a first LP signal according to an embodiment of the present disclosure. In this embodiment, the first LP-WUS format2 comprising a modulated sequence is generated by OOK modulation as the following procedure. The size of information carried by the modulated sequence is not smaller than 10 bits or 20 bits. The indication information indicated by the second type of LP-WUS includes at least one of the index information (e.g., UE ID and/or UE group ID information) and the indication information of the LP signal. The waveform of the second type of LP-WUS comprises OOK waveform.

In an embodiment, the step of OOK includes a up sampling and/or a code and/or multiplying a phase sequence. The code may include at least one of the spread code and/or a Manchester code and/or RM code and/or a polar code. The phase sequence may include at least one of a random sequence with [1 −1], a Gaussian sequence, or BPSK or QPSK or 16QAM or 64QAM.

In an embodiment, the step of M DFT includes a M-point DFT-s-OFDM process and/or mapping into physical resource, wherein M is not larger than the length of the output of OOK process.

In an embodiment, the step of IFFT is OFDM modulation that transforms the sequence from the frequency domain into the time domain.

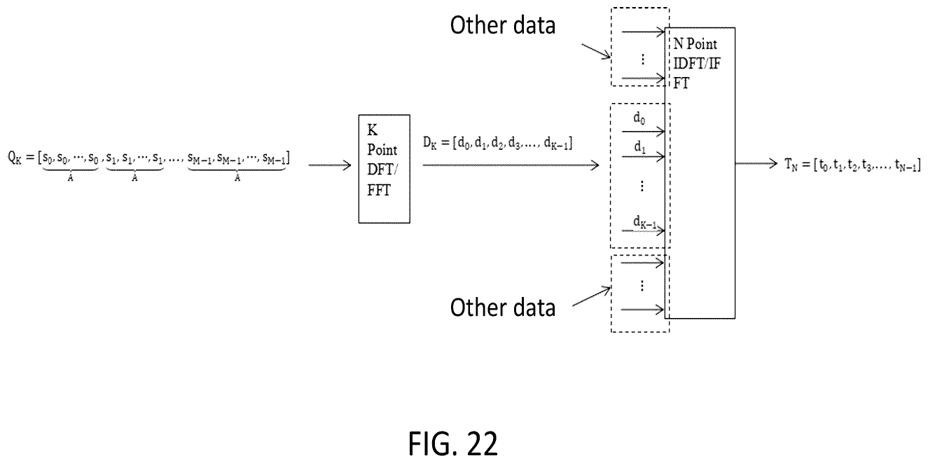

In an embodiment, the LP-WUS is generated by the OOK modulation according to steps shown in FIG. 22. In FIG. 22, it is assumed that the following steps generate M continuous OOK symbols, wherein M is not less than 1 Specifically, the M continuous OOK symbols carries M bits information S_{M}. Define S_{M}=[s₀, s₁, s₂, s₃ . . . , s_{M-1}].

Next, S_{M} is transformed into Q_{K} according to the following formula, wherein the length of Q_{K} is equal to K:

$${Q}_{K} = [ {\underbrace{{s}_{0} , {s}_{0} , ⋯ , {s}_{0}}}_{A} , {\underbrace{{s}_{1} , {s}_{1} , ⋯ , {s}_{1}}}_{A} , … , {\underbrace{{s}_{M - 1} , {s}_{M - 1} , ⋯ , {s}_{M - 1}}}_{A} ] , or$$

$${Q}_{K} = [ {\underbrace{{w}_{0}^{0} \cdot {s}_{0} , {w}_{0}^{1} \cdot {s}_{0} , ⋯ , {w}_{0}^{{A}_{0} - 1} \cdot {s}_{0}}}_{{A}_{0}} , {\underbrace{{w}_{1}^{0} \cdot {s}_{1} , {w}_{1}^{1} \cdot {s}_{1} , ⋯ , {w}_{1}^{{A}_{1} - 1} \cdot {s}_{1}}}_{{A}_{1}} , … , {\underbrace{{w}_{M - 1}^{0} \cdot {s}_{M - 1} , {w}_{M - 1}^{1} \cdot {s}_{M - 1} , ⋯ , {w}_{M - 1}^{{A}_{M - 1}} {s}_{M - 1}}}_{{A}_{M - 1}} ]$$

wherein A₀+A₁+ . . . Aᵢ+ . . . +A_{M-1}=K,
wherein the sequence

$$[ {w}_{i}^{0} , {w}_{i}^{1} , ⋯ , {w}_{i}^{{A}_{i} - 1} ]$$

can be configured by higher layer parameters, and
wherein 0≤i≤M−1.

Then, Q_{K} is processed as the following steps:
processing Q_{K} by using K point DFT/FFT to obtain sequence/data D_{K}-[d₀, d₁, d₂, d₃, . . . , d_{K-1}];
mapping sequence/data D_{K} into the K subcarriers in the frequency domain resource for the LP-WUS transmission;
when the system frequency band includes N subcarriers, filling data into N subcarriers and performing N point IDFT/IFFT process, then obtaining time domain data T_{N}[t₀, t₁, t₂, t₃, . . . , t_{N-1}]. wherein T_{N}=[t₀, t₁, t₂, t₃, . . . , t_{N-1}] is M OOK time domain symbols which is a sampled data. Wherein [t₀, t₁, t₂, t₃, . . . , t_{N/M-1}] is the first OOK symbol of the M OOK symbols. Wherein [t_{N/M}, t_{N/M+1}, . . . , t_{2N/M-1}] is the second OOK symbol of the M OOK symbols. It easy to obtain that [t_{(M-1)N/M}, t_{(M-1)N/M+1}, . . . t_{N-1}] is the M-th OOK symbol of the M OOK symbols.

Finally, Cyclic prefix (CP) is added to OOK time domain symbols and then transmit N time domain data T_{N}=[t₀, t₁, t₂, t₃, . . . , t_{N-1}], wherein the step of ‘adding CP’ includes at least one of copying the end of Ncp symbols of T_{N} to the head of T_{N} and generating (N+Ncp) time domain data, then transmitting (N+Ncp) time domain data.

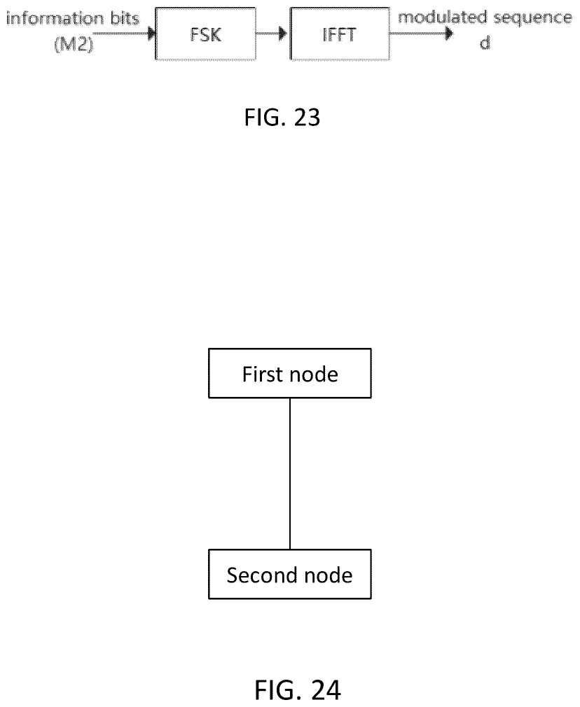

FIG. 23 shows a schematic diagram of a second LP signal according to an embodiment of the present disclosure. In this embodiment, the sequence is generated by FSK modulation as shown in FIG. 23. The waveform is generated by modulating sub-carriers of CP-OFDM symbol, wherein subcarriers carry the sequence that is the information bits modulated by FSK.

In an embodiment, the step of FSK includes at least one of the up sampling and/or a code and/or multiplying a phase sequence. The code includes at least one of the spread code and/or a Manchester code and/or RM code and/or a polar code. The phase sequence includes at least one of a random sequence with [1 −1], a Gaussian sequence, or BPSK or QPSK or 16QAM or 64QAM.

In an embodiment, adaptation of discontinuous transmission/discontinuous reception (DTX/DRX) for gNB aims at providing the necessary signaling mechanisms enabling the cell to stay inactive. Cell DTX/DRX is configured by UE-specific RRC. UE does not transmit on CG/SR occasions and monitor SPS occasions during Cell DTX non-active period. The gNB scheduling behavior for new transmissions and the related UE behaviors of PDCCH monitoring during Cell DTX non-active period are also suspended. Also, the activation/deactivation for cell DTX/DRX configuration can be indicated by a new DCI format.

In the present disclosure, the detection of the new DCI format should be designed to ensure the normal system operation, e.g. providing valid monitoring occasions for the new DCI format, or handling of the collisions with other signals/channels, or fallback mechanism for the indication of activation/deactivation for cell DTX/DRX configuration.

As used herein, including in the claims, “or” as used in a list of items (e.g., a list of items prefaced by a phrase such as “at least one of” or “one or more of”) indicates an inclusive list such that, for example, a list of at least one of A, B or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, A is “associated with” or “related to” B means that A includes B or B includes A or A includes at least one of B or B includes at least one of A.

In some embodiments, the gNB can use network DTX/DRX with restrictions due to UE DRX configurations and any configured transmission/reception, e.g., common channels/signals. Currently C-DRX is configured per UE. The alignment of the DRX cycles or offsets for different UEs can be done only via RRC. During UE DRX off duration, the UE does not expect to monitor PDCCH and receive/transmit data.

In some embodiments, the cell DTX/DRX active period includes at least one of the following cases:
a) Cell DTX/DRX on duration or a time duration when Cell DTX/DRX on duration timer is running;
b) a time duration (which at least belongs to cell DTX active period) when cell DTX inactivity timer is running;
c) a time duration when retransmission timer is running;
d) a time duration when UE is performing RACH.

For PDCCH monitoring in USS and Type-3 CSS, UE should blind detect the PDCCH based on different candidate RNTIs. While there is one kind of RNTIs (e.g. C-RNTI, MCS-C-RNTI and CS-RNTI, etc.) that scrambles both the PDCCH without data scheduling and the PDCCH for dynamic grants/assignments for new transmissions and retransmissions. Therefore, for the PDCCH scrambled by C-RNTI, MCS-C-RNTI and CS-RNTI, UE can not know whether the PDCCH carries scheduling information for new transmission or not until the UE successfully decodes the DCI carried by the PDCCH.

However, for PDCCH scrambled by this kind of RNTIs and without data scheduling, the PDCCH only indicates the information which seems not very important for the UE and UE may expect to not monitor the PDCCH during cell DTX non-active period. For example, for the PDCCH carrying DCI format 1-1 scrambled by C-RNTI, MCS-C-RNTI or CS-RNTI, the PDCCH without data scheduling may indicate SCell dormancy indication, DL SPS release and TCI state update. Therefore, considering the consistence of PDCCH monitoring behaviors between UE and gNB, we propose that UE does not monitor the PDCCH scrambled by C-RNTI, MCS-C-RNTI and CS-RNTI during cell DTX non-active periods.

For PDCCH scrambled by C-RNTI, MCS-C-RNTI and CS-RNTI and without data scheduling, the PDCCH only indicates the information which seems not very important for the UE (e.g. SCell dormancy indication, DL SPS release and TCI state update) and UE may expect to not monitor the PDCCH during cell DTX non-active period.

Considering the consistence of PDCCH monitoring behaviors between UE and gNB, we propose that UE does not monitor the PDCCH scrambled by C-RNTI, MCS-C-RNTI and CS-RNTI during cell DTX non-active periods.

For Type3-PDCCH CSS set configured by SearchSpace in PDCCH-Config with searchSpace Type common, PDCCH carrying the DCI formats with CRC scrambled by the RNTIs (e.g. SFI-RNTI, INT-RNTI, TPC-PUSCH-RNTI and TPC-PUCCH-RNTI, etc.) except for C-RNTI, MCS-C-RNTI and CS-RNTI are not used for data transmission.

Moreover, for the PDCCH scrambled by PS-RNTI (i.e. DCI format 2-6), UE should monitor the PDCCH to determine whether to start or to not start the drx-onDurationTimer for the next long DRX cycle. If UE does not expect to monitor the PDCCH during cell DTX non-active period, the UE does not have any PDCCH monitoring occasions for detection of DCI format 2-6 and should start the drx-onDurationTimer for the next long DRX cycle which leads to lack of UE power savings from the PDCCH monitoring indication. Therefore, it is proposed that the UE should monitor PDCCH scrambled by PS-RNTI during cell DTX non-active periods.

UE should monitor PDCCH scrambled by PS-RNTI (i.e. DCI format 2-6) during cell DTX non-active periods to reduce the possibility of start drx-onDurationTimer in case there is no monitoring occasions for the detection of DCI format 2-6 and UE can not save power consumption anymore from the PDCCH monitoring indication.

For Type3-PDCCH CSS set configured by SearchSpace in pdcch-ConfigMulticast, searchSpaceMCCH and searchSpaceMTCH on a secondary cell, PDCCH for multicast and broadcast (i.e. PDCCH scrambled by G-RNTI and MCCH-RNTI) can indicate the information for RRC Idle/Inactive mode UE. Considering no impacts on RRC Idle/Inactive-mode UE behaviors in WID, PDCCH scrambled by G-RNTI and MCCH-RNTI should not be impacted by the cell DTX non-active period. PDCCH for multicast scrambled by G-CS-RNTI only indicates configuration scheduling information for RRC connected-mode UE, so that the UE does not expect to monitor PDCCH scrambled by G-CS-RNTI during cell DTX non-active period.

For Type3-PDCCH CSS set configured by SearchSpace in pdcch-ConfigMulticast, searchSpaceMCCH and searchSpaceMTCH on a secondary cell, PDCCH scrambled by G-RNTI and MCCH-RNTI can indicate the information for RRC Idle/Inactive mode UE.

Considering no impacts on RRC Idle/Inactive-mode UE behaviors in WID, PDCCH for multicast and broadcast (i.e. PDCCH scrambled by G-RNTI and MCCH-RNTI) should not be impacted by the cell DTX non-active period.

UE should monitor PDCCH scrambled by G-RNTI and MCCH-RNTI during cell DTX non-active period.

Considering that PDCCH for multicast scrambled by G-CS-RNTI only indicates configuration scheduling information for RRC connected-mode UE, the UE does not expect to monitor PDCCH scrambled by G-CS-RNTI during cell DTX non-active period.

It should also be noted that the UE may be configured with PRS at the serving cell (by nr-dl-PRS-PDC-Info in ServingCellConfig) for R17 propagation delay compensation. For this PRS type, this kind of PRS may not be transmitted during cell DTX non-active period based on gNB implementation. Therefore, the PRS for Idle/Inactive-mode UE positioning procedures should not be impacted by cell DTX.

In some embodiments, during cell DTX non-active period, the UE performs at least one of the following behaviors:
a) not monitor PDCCH with data scheduling
b) not monitor PDCCH carrying a DCI format with the CRC scrambled by at least one of the C-RNTI, MCS-C-RNTI, CS-RNTI, SP-CSI-RNTI, SL-RNTI, SL-CS-RNTI, SL Semi-Persistent Scheduling V-RNTI, G-RNTI, G-CS-RNTI, and/or MCCH-RNTI.
c) not monitor PDCCH with search space configured for multicast and/or configured in pdcch-ConfigMulticast.
d) not monitor PDCCH with search space configured for broadcast and/or configured in searchSpaceMTCH.
e) not monitor SPS occasions during the Cell DTX non-active period
f) not receive PDSCH on SPS occasions during the Cell DTX non-active period
g) not report HARQ-ACK information for PDSCH reception or report NACK value(s) for HARQ-ACK information bit(s) in a HARQ-ACK codebook for the PDSCH reception, In some embodiments, the UE is configured to report the HARQ-ACK information for the corresponding PDSCH reception and SPS PDSCH release in a HARQ-ACK codebook. In some embodiments, the PDSCH reception is a PDSCH scheduled during cell DTX non-active period and/or a SPS PDSCH with the corresponding PDCCH on SPS occasions during cell DTX non-active period. UE transmits the HARQ-ACK information in a slot indicated by a value of a PDSCH-to-HARQ_feedback timing indicator field in a corresponding DCI format or provided by higher layer parameters if the PDSCH-to-HARQ_feedback timing indicator field is not present in the DCI format or used to transmit PUCCH. In some embodiments, the UE reports NACK value(s) for HARQ-ACK information bit(s) in a HARQ-ACK codebook that the UE transmits in a slot not indicated by a value of a PDSCH-to-HARQ_feedback timing indicator field in a corresponding DCI format.

In some embodiments, during cell DRX non-active period, the UE performs at least one of the following behaviors:
a) not transmit on CG occasions during Cell DRX non-active periods
b) not transmit SR occasions overlapping with Cell DRX non-active periods. In some embodiments, SR transmissions are dropped during the non-active period. In some embodiments, RRC signaling can be used to configure the UE per SR configuration with whether SR can be transmitted during Cell DRX non-active period to support high priority traffic. In some embodiments, if SR is not to be transmitted on an PUCCH occasion during Cell DRX non-active time, the UE keep the SR pending, i.e., the UE delays the SR transmission till the Cell DRX active period without triggering RACH.
c) report HARQ-ACK information if the corresponding PDSCH is a new transmission and received/scheduled during Cell DTX active period, and/or if the corresponding PDSCH is a retransmission and its new transmission is received/scheduled during Cell DTX active period.

In some embodiments, UE can perform SSB measurement and/or RACH and/or receiving paging and/or SIBs; In some embodiments, UE is a RRC idle/inactive mode UE. In some embodiments, UE can perform measurement based on PRS for RRC inactive-mode and transmit SRS for positioning.

In some embodiments, Rel-18 NES capable CONNECTED UE(s) can perform RACH and receive SIBs in non-active duration of cell DTX and/or DRX (i.e., same behavior for cell DTX and cell DRX).

In some embodiments, the Cell DTX/DRX configuration contains at least: periodicity, start slot/offset, on duration and/or inactivity timer for cell DTX. In some embodiments, a periodic cell DTX/DRX pattern is configured by UE specific RRC signaling. In some embodiments, the pattern configuration for cell DRX/DTX is common for Rel-18 UEs in the cell. In some embodiments, at least one of the parameters (including periodicity, start slot/offset, on duration) of the pattern configuration for cell DRX/DTX for different UEs in a cell has same values.

In some embodiments, Cell DTX/DRX is activated/deactivated implicitly by RRC signaling, i.e. activated immediately once configured by RRC and deactivated once the RRC configuration is released. In some embodiments, there is a benefit with L1 signaling for Cell DTX/DRX activation/deactivation. In some embodiments, the feasibility and reliability of using L1 signaling are disclosed. In some embodiments, the L1 signaling is a new DCI format (e.g. DCI format 2_8). In some embodiments, the new DCI format belongs to Type3-PDCCH CSS set. In some embodiments, the CRC of the new DCI format is scrambled by a new RNTI (e.g. network energy saving-RNTI, NES-RNTI or network power saving-RNTI, NPS-RNTI). It can avoid the UE stopping the PDCCH monitoring for the new DCI format during cell DTX non-active periods.

In some embodiments, the PDCCH monitoring for new DCI format is configured in PCell, SpCell or the cell configured for the Rel-18 NES capable CONNECTED UEs or UEs supporting Rel-18 NES operation.

In some embodiments, there are three monitoring schemes for new DCI format:

Method 1: monitoring PDCCH for detection of new DCI format according to the search space set configuration.

In some embodiments, the UE applies the activation/deactivation of cell DTX/DRX configuration indicated by new DCI format after an application delay from the slot/monitoring occasion of detecting the new DCI format.

Based on the method 1, there are a mount of monitoring occasions to provide the UE with better reliability and flexibility for the detection of new DCI format according to the search space set configuration.

Method 2: monitoring PDCCH for detection of new DCI format during a time window prior to next cell DTX/DRX cycle

In some embodiments, the time window is determined by at least one of reference point, start offset, minimum gap and search space set. In some embodiments, start offset is used to indicate the starting position prior to the next cell DTX/DRX cycle. In some embodiments, the reference point is at least one of the start of next cell DTX/DRX cycle, the start of next cell DTX/DRX on duration, the start of the next cell DTX/DRX active period and the start of current cell DTX/DRX cycle that the UE detects the new DCI format. In some embodiments, the minimum gap is used to indicate the interval between the end of time window and the reference point. In some embodiments, the start offset is not larger than the subtraction of cell DTX/DRX cycle and at least one of 1) the cell DTX/DRX on duration; or 2) cell DTX inactivity timer; or 3) the addition of cell DTX/DRX on duration and cell DTX inactivity timer.

In some embodiments, at least one of the time window, the reference point, start offset and minimum gap is only valid or available when the cell DTX/DTX configuration is activated.

In some embodiments, if the cell DTX/DRX configuration is in activated state, the reference point is the start of next cell DTX/DRX cycle/on duration and UE deactivates the cell DTX/DRX configuration from the next cell DTX/DRX cycle/on duration. In some embodiments, if the cell DTX/DRX configuration is in deactivated state, the reference point is the slot/symbols of the monitoring occasion that UE detects the new DCI format and/or the UE activates the cell DTX/DRX configuration after an application delay from the reference point when the UE receives the indication of activation of cell DTX/DRX configuration. This method can avoid the UE wasting more power consumption if UE should have activated the cell DTX/DRX configuration because of the new DCI format detecting or decoding error and all of UEs deactivates the cell DTX/DRX configuration at the same reference point.

In some embodiments, if the cell DTX/DRX configuration is in deactivated state, the reference point is the start of next cell DTX/DRX cycle/on duration and UE activates the cell DTX/DRX configuration from the next cell DTX/DRX cycle/on duration. In some embodiments, if the cell DTX/DRX configuration is in activated state, the reference point is the slot/symbols of the monitoring occasion that UE detects the new DCI format and/or the UE deactivates the cell DTX/DRX configuration after an application delay from the reference point when the UE receives the indication of deactivation of cell DTX/DRX configuration. This method can avoid the UE missing the data scheduling if UE should have deactivated the cell DTX/DRX configuration but activates the cell DTX/DRX cycle wrong because of the new DCI format detecting or decoding error.

Based on Method 2, the UE can save more power consumption in PDCCH monitoring for the detection of new DCI format during a time window.

In some embodiments, if the cell DTX configuration and cell DRX configuration have different parameters' values (e.g. start offset, periodicity), a first time window is configured for the cell DTX configuration and the second time window is configured for the cell DRX configuration.

In some embodiments, the first time window and the second time window have same reference point. In some embodiments, the reference point is at least one of the start of next cell DTX cycle, the start of next cell DTX on duration, the start of the next cell DTX active period and the start of current cell DTX cycle that the UE detects the new DCI format if the UE is provided with cell DTX configuration by RRC signaling. It can avoid the misalignment of application time of the activation/deactivation of cell DTX/DRX configuration indicated by new DCI format.

In some embodiments, the first time window and the second time window have different reference point. In some embodiments, the reference point of the first time window is at least one of the start of next cell DTX cycle, the start of next cell DTX on duration, the start of the next cell DTX active period and the start of current cell DTX cycle that the UE detects the new DCI format. In some embodiments, the reference point of the second time window is at least one of the start of next cell DRX cycle, the start of next cell DRX on duration, the start of the next cell DRX active period and the start of current cell DRX cycle that the UE detects the new DCI format only when the UE is not provided with cell DRX configuration by RRC signaling.

In some embodiments, if the first time window is overlapped with the second time window, the UE assumes the first monitoring occasion or the monitoring occasion that is closest to and prior to the next cell DTX cycle and/or the cell DRX cycle as the monitoring occasion for the detection of new DCI format during the whole time duration of the first and the second time window.

In some embodiments, if there are more than one time window or monitoring occasion or detection of new DCI format before the reference point, the UE shall assume the most recent monitoring occasion or detection of new DCI format before the reference point as the indication of activation/deactivation of cell DTX/DRX configuration.

In some embodiments, the value of activation/deactivation of cell DTX/DRX configuration indicated by the new DCI format should be consistent during the monitoring occasions before the same reference point or prior to the next cell DTX/DRX cycle.

In some embodiments, the above monitoring occasion is according to the search space set configured for the PDCCH carrying the new DCI format.

In some embodiments, if the UE is configured with search space set for detection of new DCI format and the UE is not required to monitor PDCCH for detection of new DCI format, as described in clauses 10, 11 and 12 of TS 38.213, and in clause 5.7 of TS 38.321 for all corresponding PDCCH monitoring occasions during cell DTX/DRX non-active period prior to a next cell DTX/DRX cycle, or the UE does not have any PDCCH monitoring occasions for detection of new DCI format during cell DTX/DRX non-active period, the physical layer of the UE reports a value for the current cell DTX/DRX state or a default indication of cell DTX/DRX configuration to higher layers for the next cell DTX/DRX cycle. In some embodiments, the default indication of cell DTX/DRX configuration is deactivation of cell DTX/DRX configuration or activation of cell DTX/DRX configuration.

Method 3: the indication information of activation/deactivation of cell DTX/DRX configuration is carried by MAC CE. In some embodiments, the UE applies the indication after 3 milliseconds from the slot of MAC CE reception. Based on method 3, the indication of activation/deactivation of cell DTX/DRX configuration has corresponding HARQ-ACK information report.

For activation/deactivation of cell DTX/DRX configurations for multiple cells, i.e. CA scenario, the UE can monitor the new DCI format in PCell and the content field of new DCI format can indicate activation/deactivation of cell DTX/DRX configurations for one or more cells or groups of cells. One-bit field can be used to indicate activation/deactivation of cell DTX/DRX configuration for single cell or a group of cells. A bitmap can be used to indicate activation/deactivation of cell DTX/DRX configuration for multiple cells or groups of cells so that the bit width of the bitmap can be equal to the number of cells or cell groups and each bit corresponds to the indication for a cell or a group of cell. In order to simplify the cell DTX/DRX operation and reduce the signaling overhead, the cells with the same cell DTX/DRX parameters (e.g. same offset) are preferred to be bundled into a group of cells.

In order to simplify the cell DTX/DRX operation and reduce the signaling overhead, the cells with the same cell DTX/DRX parameters (e.g. same offset) are preferred to be bundled into a group of cells.

In some embodiments, the content field of the new DCI format is shown as followings:
Block number 1, block number 2, . . . , block number N

For each block should at least support the following:
DTX configuration activation/deactivation
DRX configuration activation/deactivation

In some embodiments, N is the number of UEs or UE groups or UE subgroups. In some embodiments, UE is configured with the start bit position of the block in new DCI format by RRC signaling. In some embodiments, the gNB can configure multiple UEs with a same start bit position of the block so that the signaling overhead can be reduced.

In some embodiments, if the cell DTX/DRX configuration can be used for multiple cells, the content field format can be the following:
a) multiple cells have the same/common cell DTX/DRX configuration. For this case, the field of DTX configuration activation/deactivation and the field of DRX configuration activation/deactivation in a block occupy 1 bit separately and each bit is used for the multiple cells.

In some embodiments, 1-bit indication for DTX configuration activation/deactivation and 1-bit indication for DRX configuration activation/deactivation. In some embodiments, each bit corresponds to DTX/DRX configuration activation/deactivation for one or multiple cells. In some embodiments, at least one of the cell DTX/DRX start offset, on duration and periodicity is configured as same value among multiple cells when UE supports different number of cells. In some embodiments, the multiple cells are in a group of cell.

In some embodiments, the 1-bit indication for DTX configuration activation/deactivation and 1-bit indication for DRX configuration activation/deactivation for multiple cells are only used to indicate DTX configuration deactivation and/or DRX configuration deactivation.

For example, the content field is shown as following:
Block number 1, block number 2, . . . , block number N

For each block should at least support the following:
DTX configuration activation/deactivation
DRX configuration activation/deactivation

In some embodiments, DTX/DRX configuration activation/deactivation is used to indicate to activate/deactivate the DTX/DRX configuration in the cells supported by the UE.

In some embodiments, if a cell supported by the UE is not provided with the DTX/DRX configuration, the UE ignores the indication of DTX/DRX configuration activation/deactivation for the cell. In some embodiments, the UE applies the DTX/DRX configuration activation/deactivation indicated by the new DCI format for the cell that is provided with cell DTX/DRX configuration.
b) a bitmap is used to indicate DTX configuration activation/deactivation and a bitmap for DRX configuration activation/deactivation respectively. In some embodiments, each bit of the bitmap corresponds to the DTX/DRX configuration activation/deactivation for a cell/a group of cells.

For example, the content field is shown as following:
Block number 1, block number 2, . . . , block number N

For each block should at least support the following:
DTX configuration activation/deactivation
DRX configuration activation/deactivation

In some embodiments, each field of DTX configuration activation/deactivation and DRX configuration activation/deactivation has 0˜M bits. In some embodiments, M is the number of cells/the number of groups of cells supported by the UE and/or supporting cell DTX/DRX operation.

In some embodiments, each field of DTX configuration activation/deactivation and DRX configuration activation/deactivation has 0˜M bits. In some embodiments, N is the number of cells/the number of groups of cells supported by the UE and/or supporting cell DTX/DRX operation. In some embodiments, M is the number of UEs or UE groups or UE subgroups.

In some embodiments, for CA scenario, the content field format can used at least one of the above content field formats. In some embodiments, the UE applies the activation/deactivation of cell DTX/DRX configuration for PCell, SCells which is not in SCell dormancy state and a number of group of Scells.
c) Each block is used to indicate the information for a cell. In some embodiments, UE obtains the position of its cell DTX/DRX configuration activation/deactivation information according to the configuration from RRC signaling.

For example, the content field is shown as following:
Block number 1, block number 2, . . . , block number N

For each block should at least support the following:
DTX configuration activation/deactivation
DRX configuration activation/deactivation

In some embodiments, N is the number of cells or the number of groups of cell for the UE or a group of UE or all of UEs supporting detection of new DCI format.
d) One block is used to indicate the information for one or more UEs. In some embodiments, the block comprises a bitmap for DTX configuration activation/deactivation and a bitmap for DRX configuration activation/deactivation. In some embodiments, the bit width of the bitmap is M.

For example, the content field is shown as following:

The only one block should at least support the following:
DTX configuration activation/deactivation
DRX configuration activation/deactivation

In some embodiments, M is the number of UEs/UE groups/UE subgroups. In some embodiments, each bit of the bitmap corresponds to the cell DTX/DRX configuration activation/deactivation indication information for each UE/UE group/UE subgroup. In some embodiments, UE obtains the position of its cell DTX/DRX configuration activation/deactivation information according to the configuration from RRC signaling.

In some embodiments, M is the number of cell DTX/DRX configurations for the UE. In some embodiments, each bit is used to indicate the configuration activation/deactivation for cell(s)/the group(s) of cells supported by the UE and/or supporting cell DTX/DRX operation.

In some embodiments, if UE detects new DCI format, the UE shall not monitor PDCCH and/or receiving a new indication of DTX/DRX configuration activation/deactivation during the application delay after the slot/symbol for the detection of new DCI format.

In some embodiments, if UE receives DTX/DRX configuration activation/deactivation indicated by MAC CE, the UE shall not monitor PDCCH and/or receiving a new indication of DTX/DRX configuration activation/deactivation during 3 ms after the slot/symbol for the MAC CE reception.

In some embodiments, a timer is used to trigger DTX/DRX configuration activation/deactivation. If UE detects the DCI/MAC CE indicating DTX/DRX configuration deactivation, the UE shall set the timer as the value configured by RRC signaling. In some embodiments, if the timer is expired, the UE shall apply DTX/DRX configuration activation or activate the DTX/DRX configuration. In some embodiments, if the timer is running and the UE monitors PDCCH carrying DCI with the CRC scrambled by the RNTIs associated with data scheduling or PDCCH scheduling SPS and/or CG data and/or msg1 and/or msg3, the UE shall reset the timer as the value configured by RRC signaling. In some embodiments, the RNTIs associated with data scheduling include at least one of C-RNTI, MCS-C-RNTI, CS-RNTI, SP-CSI-RNTI, MCCH-RNTI, G-RNTI and/or G-CS-RNTI.

In some embodiments, the candidate timer values include at least one of the followings:
a) timer values are configured by RRC signaling. In some embodiments, the minimum value is not smaller than 1/32 ms. In some embodiments, the maximum value is not larger than cell DTX/DRX cycle and/or the subtraction between the maximum cell DTX/DRX cycle and the minimum cell DTX/DRX on duration.
b) the unit of time value is millisecond. It can avoid messing up the timing between different SCS configuration for cells or BWPs.

In some embodiments, when the timer expires in the first slot, the UE starts performing DTX/DRX configuration activation from the second slot. In some embodiments, the second slot is satisfied with at least one of the followings:
a) is not earlier than the symbols of an application delay after the first slot,
b) is not earlier than a slot where a PDCCH skipping duration expires, if applicable
c) is not earlier than a slot where a cell DTX/DRX on duration/cycle is started, and/or
d) is not earlier than a slot where a UE CDRX on duration/cycle is started

In some embodiments, UE features associated with the indication of DTX/DRX configuration activation/deactivation comprise at least one of the UE supporting DCI to trigger DTX/DRX configuration activation/deactivation, and/or the UE supporting MAC CE to trigger DTX/DRX configuration activation/deactivation, and/or the UE supporting both DCI and MAC CE to trigger DTX/DRX configuration activation/deactivation, and/or the UE supporting the timer behavior to trigger DTX/DRX configuration activation/deactivation, and/or the UE supporting the DCI triggering the timer behavior of setting timer value and/or starting running timer. In some embodiments, if UE feature indicates UE supporting both DCI and MAC CE to trigger DTX/DRX configuration activation/deactivation, the UE shall detects the indication information of DTX/DRX configuration activation/deactivation according to the configuration by RRC signaling. For example, RRC signaling configures a priority level for the UE features that the UE supporting DCI to trigger DTX/DRX configuration activation/deactivation, and/or the UE supporting MAC CE to trigger DTX/DRX configuration activation/deactivation.

In some embodiments, if HARQ-ACK information for the SPS PDSCH release and the SPS PDSCH reception(s) would map to different PUCCHs or not be multiplexed in a same PUCCH, and if the UE would feedback HARQ-ACK information for the SPS PDSCH release during cell DRX non-active time, the UE shall feedback the HARQ-ACK information for SPS PDSCH release during cell DRX non-active time.

In some embodiments, if a UE detects a DCI format 1_1 indicating
SCell dormancy without scheduling a PDSCH reception, as described in clause 10.3, and
is provided pdsch-HARQ-ACK-Codebook=dynamic or pdsch-HARQ-ACK-Codebook-r16,
and if the UE would feedback the HARQ-ACK information for the DCI format 1_1 during cell DTX/DRX non-active period,
the UE shall feedback and/or ignore the HARQ-ACK information for the DCI format 1_1 during cell DRX non-active period.

FIG. 24 shows a schematic diagram of a network (architecture) according to an embodiment of the present disclosure. In FIG. 24, a first node communicates with a second node. In an embodiment, the first node is a BS (e.g., gNB) and the second node is a UE.

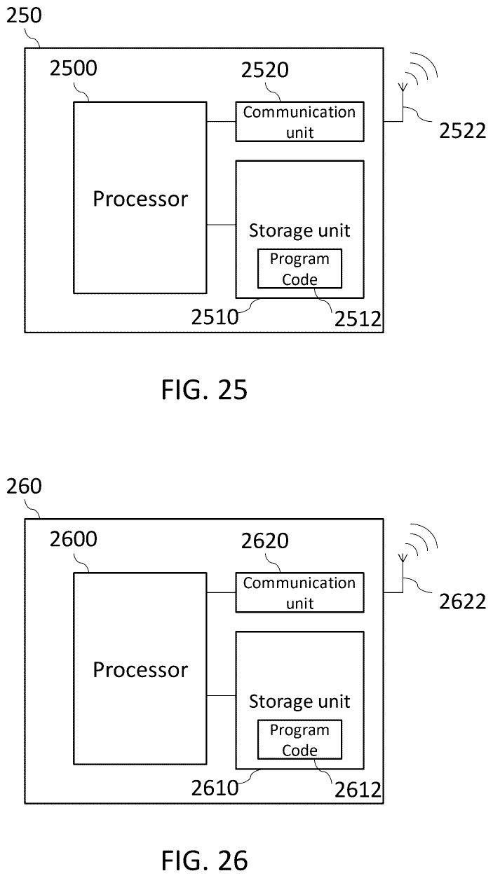

FIG. 25 relates to a schematic diagram of a wireless terminal 250 according to an embodiment of the present disclosure. The wireless terminal 250 may be a user equipment (UE), a mobile phone, a laptop, a tablet computer, an electronic book or a portable computer system and is not limited herein. The wireless terminal 250 may include a processor 2500 such as a microprocessor or Application Specific Integrated Circuit (ASIC), a storage unit 2510 and a communication unit 2520. The storage unit 2510 may be any data storage device that stores a program code 2512, which is accessed and executed by the processor 2500. Embodiments of the storage unit 2510 include but are not limited to a subscriber identity module (SIM), read-only memory (ROM), flash memory, random-access memory (RAM), hard-disk, and optical data storage device. The communication unit 2520 may a transceiver and is used to transmit and receive signals (e.g., messages or packets) according to processing results of the processor 2500. In an embodiment, the communication unit 2520 transmits and receives the signals via at least one antenna 2522 shown in FIG. 25.

In an embodiment, the storage unit 2510 and the program code 2512 may be omitted and the processor 2500 may include a storage unit with stored program code.

The processor 2500 may implement any one of the steps in exemplified embodiments on the wireless terminal 250, e.g., by executing the program code 2512.

The communication unit 2520 may be a transceiver. The communication unit 2520 may as an alternative or in addition be combining a transmitting unit and a receiving unit configured to transmit and to receive, respectively, signals to and from a wireless network node (e.g., a base station).

FIG. 26 relates to a schematic diagram of a wireless network node 260 according to an embodiment of the present disclosure. The wireless network node 260 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 260 may comprise (perform) at least one network function such as an access and mobility management function (AMF), a session management function (SMF), a user place function (UPF), a policy control function (PCF), an application function (AF), etc. The wireless network node 260 may include a processor 2600 such as a microprocessor or ASIC, a storage unit 2610 and a communication unit 2620. The storage unit 2610 may be any data storage device that stores a program code 2612, which is accessed and executed by the processor 2600. Examples of the storage unit 2610 include but are not limited to a SIM, ROM, flash memory, RAM, hard-disk, and optical data storage device. The communication unit 2620 may be a transceiver and is used to transmit and receive signals (e.g., messages or packets) according to processing results of the processor 2600. In an example, the communication unit 2620 transmits and receives the signals via at least one antenna 2622 shown in FIG. 26.

In an embodiment, the storage unit 2610 and the program code 2612 may be omitted. The processor 2600 may include a storage unit with stored program code.

The processor 2600 may implement any steps described in exemplified embodiments on the wireless network node 260, e.g., via executing the program code 2612.

The communication unit 2620 may be a transceiver. The communication unit 2620 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method for use in a wireless terminal, the wireless communication method comprising:
receiving, from a wireless network node, configuration information of a low-power (LP) signal, and
monitoring the LP signal based on the configuration information,
wherein the LP signal comprises a first LP signal and a second LP signal, and
wherein the first LP signal carries one or more indication information bits, wherein the indication information indicated by the first LP signal comprises: a wireless terminal group identifier (ID) and a wireless terminal sub-group ID,
wherein the first LP signal includes a first block and a second block, wherein:
the first block and the second block indicate the same information bits;
the first block is generated by at least one of following steps: a sequence used to modulate information bits of the first low-power signal, a segmentation method, discrete Fourier transform (DFT) operation and adding padding bits,
the second block is generated by at least one of the following steps: Reed-Muller (RM) code, binary phase shift keying (BPSK) modulation, on-off keying (OOK) modulation, or Manchester code with code rate of 1/2.

2. The wireless communication method of claim 1, wherein:
the first LP signal is used to trigger physical downlink control channel (PDCCH) monitoring;
the second LP signal is used to trigger the first LP signal monitoring; and
if the resource for the first LP signal transmission is overlapped or collided with the resource for second LP signal, the wireless terminal ignores the resource for the first LP signal transmission.

3. The wireless communication method of claim 1, wherein the first block and the second block have the same frequency resource.

4. A wireless communication method for use in a wireless network node, the wireless communication method comprising:
transmitting, to a wireless terminal, configuration information of a low-power (LP) signal, and
transmitting the LP signal based on the configuration information,
wherein the LP signal comprises a first LP signal and a second LP signal, and
wherein the first LP signal carries one or more indication information bits, wherein the indication information indicated by the first LP signal comprises: a wireless terminal group identifier (ID) and a wireless terminal sub-group ID,
wherein the first LP signal includes a first block and a second block, wherein:
the first block and the second block indicate the same information bits;
the first block is generated by at least one of the following steps: a sequence used to modulate information bits of the first low-power signal, a segmentation method,
discrete Fourier transform (DFT) operation and adding padding bits,
the second block is generated by at least one of following steps: Reed-Muller (RM) code, binary phase shift keying (BPSK) modulation, on-off keying (OOK) modulation, or Manchester code with code rate of 1/2.

5. The wireless communication method of claim 4, wherein:
the first LP signal enables the wireless terminal to trigger physical downlink control channel (PDCCH) monitoring;
the second LP signal enables the wireless terminal to trigger the first LP signal monitoring; and
if the resource for the first LP signal transmission is overlapped or collided with the resource for second LP signal, the wireless terminal is enabled to ignore the resource for the first LP signal transmission.

6. The wireless communication method of claim 4, wherein the first block and the second block have the same frequency resource.

7. A wireless terminal, comprising:
a communication unit, configured to receive, from a wireless network node, configuration information of a low-power (LP) signal, and
a processor, configured to monitor the LP signal based on the configuration information,
wherein the LP signal comprises a first LP signal and a second LP signal, and
wherein the first LP signal carries one or more indication information bits, wherein the indication information indicated by the first LP signal comprises: a wireless terminal group identifier (ID) and a wireless terminal sub-group ID,
wherein the first LP signal includes a first block and a second block, wherein:
the first block and the second block indicate the same information bits;
the first block is generated by at least one of the following steps: a sequence used to modulate information bits of the first low-power signal, a segmentation method, discrete Fourier transform (DFT) operation and adding padding bits,
the second block is generated by at least one of the following steps: Reed-Muller (RM) code, binary phase shift keying (BPSK) modulation, on-off keying (OOK) modulation, or Manchester code with code rate of 1/2.

8. The wireless terminal of claim 7, wherein:
the first LP signal is used to trigger physical downlink control channel (PDCCH) monitoring;
the second LP signal is used to trigger the first LP signal monitoring; and
if the resource for the first LP signal transmission is overlapped or collided with the resource for second LP signal, the wireless terminal ignores the resource for the first LP signal transmission.

9. The wireless communication method of claim 7, wherein the first block and the second block have the same frequency resource.
